(19) United States
(12) Patent Application Publication
(10) Pub. No.: US 2026/0292782 A1
(43) Pub. Date: Sep. 24, 2026

(54) METHODS FOR OBTAINING ASSISTANCE DATA FOR AIML-BASED POSITIONING

(71) Applicant: InterDigital Patent Holdings, Inc., Wilmington, DE (US)

(72) Inventors: Fumihiro Hasegawa, Westmount (CA); Yugeswar Deenoo Narayanan Thangaraj, Chalfont, PA (US); Young Woo Kwak, Woodbury, NY (US); Samir Ferdi, Kirkland (CA); Dylan Watts, Montreal (CA); Paul Marinier, Brossard (CA); Moon Il Lee, Melville, NY (US)

(73) Assignee: InterDigital Patent Holdings, Inc., Wilmington, DE (US)

(21) Appl. No.: 19/088,586

(22) Filed: Mar. 24, 2025

(51) Int. Cl. H04W 64/00

(52) U.S. Cl. CPC H04W 64/006

(57) ABSTRACT

Systems, methods, and instrumentalities for obtaining assistance data for AIML-based positioning are disclosed herein. A WTRU may transmit, to a network, a request for one or more line of sight (LOS) indicators, where each LOS indicator may be associated with a respective sounding reference signal (SRS). The WTRU may receive one or more configurations to transmit the respective SRSs associated with the one or more LOS indicators. The WTRU may receive the one or more LOS indicators associated with the respective SRSs from the network. The WTRU may determine a first LOS indicator of the received one or more LOS indicators that has a highest value among the received one or more LOS indicators. The WTRU may associate an uplink channel with an SRS associated with the first LOS indicator and may transmit one or more uplink transmissions using the uplink channel.

### BACKGROUND

In the current framework, determination of spatial relation information of a WTRU may require one or more (e.g., at least four) steps. If the WTRU rotates/moves, determination of spatial information may need to be repeated, which may increase signaling overhead. Methods for the WTRU to determine spatial information for UL transmission after the WTRU-side condition changes (e.g., rotation) may be desired.

### SUMMARY

Systems, methods, and instrumentalities for obtaining assistance data for AIML-based positioning are disclosed herein. One or more of the methods disclosed herein may be performed by a user equipment (UE) (e.g., a wireless transmit/receive unit (WTRU)), for example via a processor thereof.

A WTRU may receive, from a network, a request to become a contributor for data collection. The WTRU may transmit a response message to the network agreeing to become a contributor for data collection, and may receive a confirmation message confirming registration of the WTRU as a contributor for data collection. The WTRU may transmit, to the network, a request for one or more line of sight (LOS) indicators, where each LOS indicator may be associated with a respective sounding reference signal (SRS). The request for the one or more LOS indicators may comprise identifiers (e.g., SRS IDs, SRS resource IDs) associated with the respective SRSs associated with the one or more LOS indicators and/or one or more TRP IDs. The WTRU may receive, from the network, one or more configurations to transmit the respective SRSs associated with the one or more LOS indicators. The WTRU may transmit, to the network, the respective SRSs associated with the one or more LOS indicators, and may receive the one or more LOS indicators associated with the respective SRSs from the network. The WTRU may determine a first LOS indicator of the received one or more LOS indicators, where the first LOS indicator has a highest value among the received one or more LOS indicators. The WTRU may associate an uplink channel (e.g., PUSCH) with an SRS associated with the first LOS indicator and may transmit one or more uplink transmissions using the uplink channel associated with the SRS associated with the first LOS indicator. The WTRU may determine a spatial filter to transmit the one or more uplink transmissions based on the received one or more LOS indicators.

The WTRU may determine that a trigger condition is satisfied. For example, the WTRU may determine that at least one of an orientation of the WTRU or a location of the WTRU has changed by a threshold amount (e.g., the WTRU has rotated by more than the threshold amount). The WTRU may update the one or more LOS indicators associated with the respective SRSs. The WTRU may determine a second LOS indicator of the one or more LOS indicators, where the second LOS indicator has a highest value among the updated one or more LOS indicators, and may associate the uplink channel with an SRS associated with the second LOS indicator. The WTRU may transmit, to the network, an indication that the uplink channel is associated with the SRS associated with the second LOS indicator.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of using an AIML model to obtain a WTRU location.

FIG. 3 illustrates an example of a hierarchical structure of PRS configurations.

FIG. 4 illustrates an example gNB-AIML model with intermediate KPIs (e.g., LOS indicator(s)) generated based on SRS measurements.

FIG. 5 illustrates an example of determination of spatial information.

FIG. 6 illustrates an example of a call flow between a network and a WTRU to become a contributor for data collection.

FIG. 7 illustrates an example LOS indicator for SRS.

FIG. 8 illustrates an example of using an LOS indicator value for each SRS to determine an optimal beam for UL transmission when a WTRU condition (e.g., rotation) changes

FIG. 9 illustrates an example of collision between two SRSs.

FIG. 10 illustrates an example of collision avoidance.

FIG. 11 illustrates an example of partial dropping.

FIG. 12 illustrates an example of association of SRS configuration and a WTRU-side condition.

FIG. 13 illustrates an example of a WTRU's determination of a metric associated with SRS after a WTRU-side condition changes.

FIG. 14 illustrates an example call flow between a WTRU and a gNB.

FIG. 15 illustrates another example call flow between a WTRU and a gNB

FIG. 16 illustrates an example of a relationship between one or more WTRUs, an AIML training server, an LFM, and a gNB.

FIG. 17 illustrates an example of a relationship between an amount of measurements reported by a WTRU and a quality of a generated ground truth.

FIG. 18 illustrates an example of a start and end time of measurements to be used for generation of ground truth(s).

FIG. 19 illustrates an example of requesting and acquisition of a ground truth.

FIG. 20 illustrates another example of requesting and acquisition of a ground truth.

### DETAILED DESCRIPTION

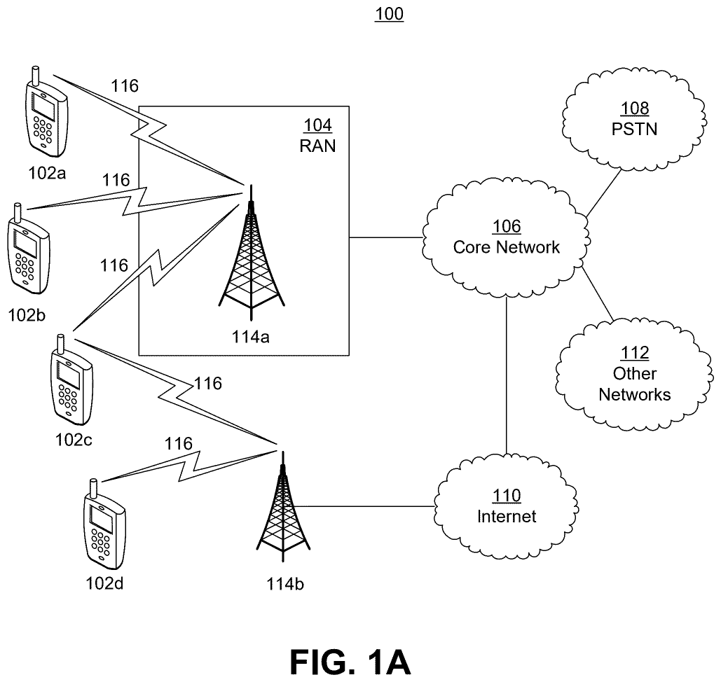

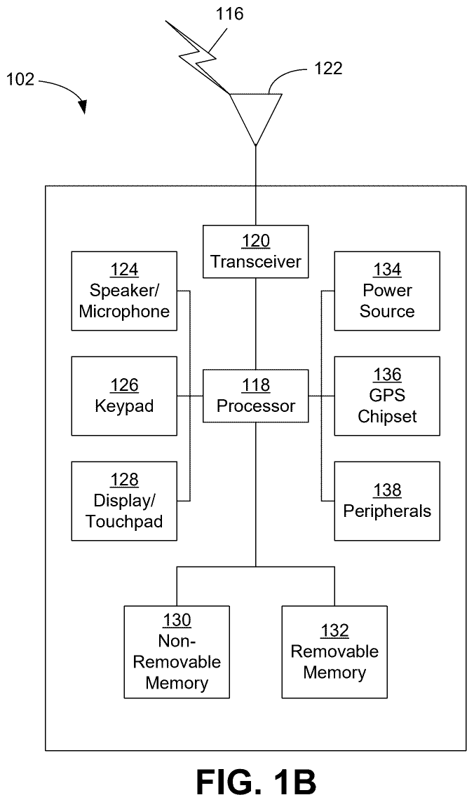

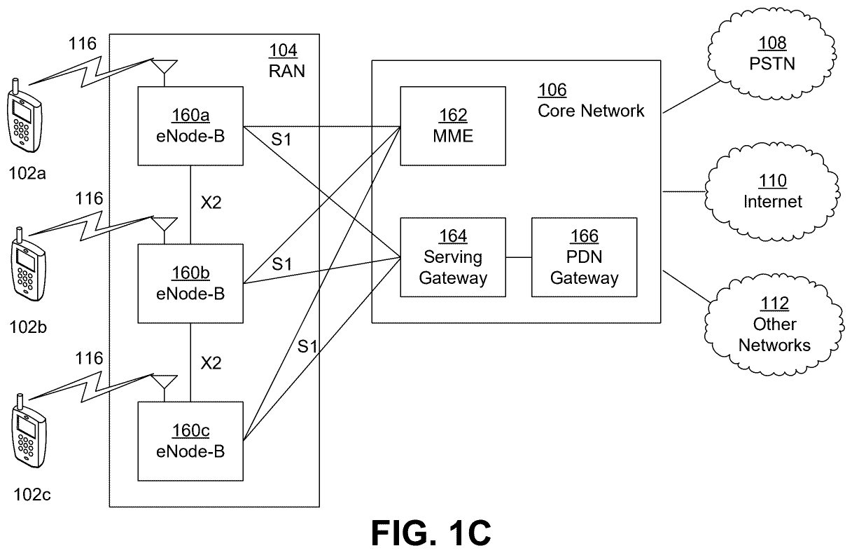

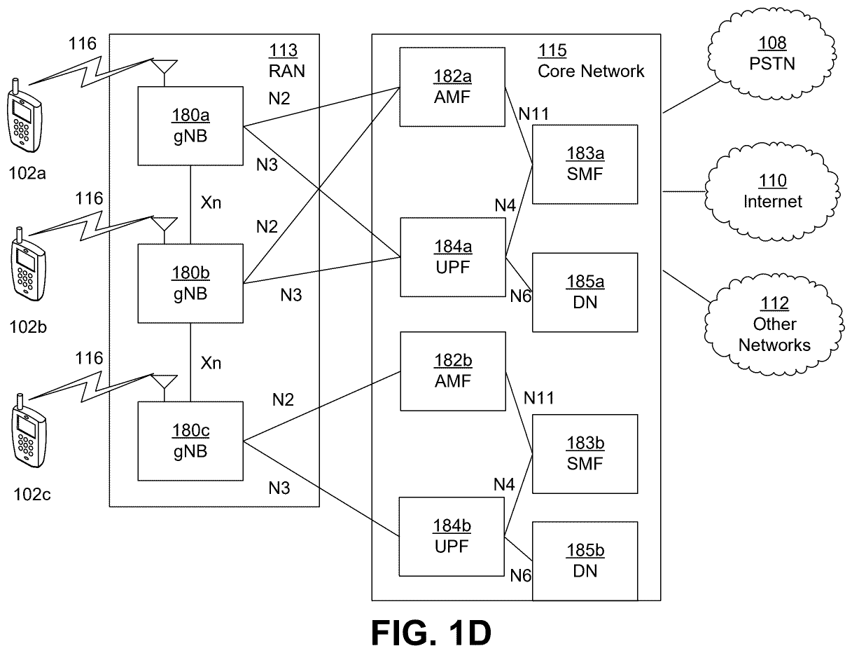

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A gNB may have an artificial intelligence/machine learning (AIML) model that may generate an LOS indicator. A wireless transmit/receive unit (WTRU) may receive a request from the network to transmit SRS. The gNB may collect measurements from the received SRS and train the AIML model.

General WTRU behavior may be disclosed herein. The WTRU may send a request to the network for configuration(s) (e.g., DL-RS configurations, UL RS configurations) in PUSCH, PUCCH, UCI, MAC-CE, RRC or LPP message. The request from the WTRU may include configurations of a measurement gap, DL-RS processing window or window for transmission of UL RS.

The WTRU may send an acknowledgement message in PUSCH or PUCCH for the grant received from the network.

More than one condition/criteria may be used in a combination. The WTRU may be configured with more than one condition and associated WTRU behavior, and the WTRU may determine which behavior the WTRU shall use based on the applicable condition(s).

The WTRU may measure DL-RS inside or outside of an active BWP. The WTRU may transmit UL RS inside or outside of the active BWP.

The WTRU may be preconfigured with parameters (e.g., measurement gaps, DL-RS processing windows, DL-RS configurations, UL RS configurations) via a semi-static message (e.g., LPP, RRC).

The WTRU may report measurements or configuration parameters in a semi-static message (e.g., LPP, RRC) or dynamic message (e.g., UCI, MAC-CE).

Any actions the WTRU determines to take may be configured by the network. For example, the WTRU may be configured with a rule and according to the rule, the WTRU may determine to take an associated action.

In addition to the measurements made on DL-RS, the WTRU may include at least one of the following cell-related measurements: SSB RSRP from the serving cell with corresponding cell ID; SSB RSRP from the neighboring cell(s) with corresponding cell ID(s); RSRP of CSI-RS with CSI-RS resource ID; and/or RSRP of DM-RS.

As used herein, the term “network” may include one or more of AMF, LMF, gNB and/or NG-RAN.

The terms “pre-configuration” and “configuration” may be used interchangeably herein.

The terms “non-serving gNB” and “neighboring gNB” may be used interchangeably herein.

The terms “gNB” and “TRP” may be used interchangeably herein.

The terms “DL-RS” and “DL-RS resource” may be used interchangeably herein.

The terms “DL-RS(s)” and “DL-RS resource(s)” may be used interchangeably herein. The DL-RS(s) or DL-RS resource(s) may belong to the same or different DL-RS resource sets.

The terms “measurement gap” and “measurement gap pattern” may be used interchangeably herein. A measurement gap pattern may include parameters such as measurement gap duration, measurement gap repetition period, and/or measurement gap periodicity.

An LMF may be a non-limiting example of a node or entity (e.g., network node or entity) that may be used for or to support positioning or sensing. Any other node or entity may be substituted for LMF and still be consistent with the embodiments disclosed herein.

The WTRU may receive a preconfigured threshold(s) from the network (e.g., LMF, gNB).

An LOS indicator may be a hard (e.g., 1 or 0) or soft indicator (e.g., 0, 0.1, 0.2 . . . , 1) and it may indicate a likelihood of the presence of an LOS path between TRP and WTRU, or along DL-RS. The LOS indicator may be associated with a TRP or PRS resource ID (e.g., index). The WTRU may receive the LOS indicator from the network per TRP or resource ID. Alternatively, the WTRU may determine the LOS indicator per TRP or resource ID based on measurements. Similarly, the NLOS indicator may indicate likelihood of the presence of an NLOS path between TRP and WTRU, or along DL-RS.

The terms “ID” and “index” may be used interchangeably herein.

The terms “training” and “data collection” may be used interchangeably herein.

The terms “SRS,” “SRSp,” and “SRS for positioning” may be used interchangeably herein.

The terms “WTRU-side condition,” “WTRU condition,” and/or “WTRU implementation” may be used interchangeably herein.

A WTRU location may be expressed in terms of altitude, latitude, geographic coordinate, and/or local coordinate, for example.

In the embodiments described herein, a timestamp be indicated by absolute time, relative time (e.g., in seconds) compared to a reference time, SFN, slot index, frame index, subframe index and/or symbol index. Examples of “absolute time” may be UTC time, GNSS time, locally defined absolute time (e.g., LTE or NR Time).

In the embodiments described herein, the WTRU may receive configurations for a time window such as duration (e.g., expressed in terms of seconds, number of symbols, number of slots, number of frames, number of subframes), start and/or end time (e.g., expressed in terms of absolute time, system time, relative time with respect to a reference time indicated by the network or determined by the WTRU, SNF index, slot index, symbol index, frame index, subframe index). The WTRU may receive more than one configuration of a time window, where a (e.g., each) configuration is associated with an index. The time window may be initiated with a trigger sent by the network. For example, the WTRU may receive a command (e.g., DCI) to initiate an indicated time window, indicated via the configuration index. For example, a time window may be initiated by a DCI. The WTRU may receive the DCI from the network, and the DCI may indicate a timing at which the time window shall be activated. The timing may be a relative timing (e.g., N slots or symbols from the timing the WTRU received the DCI) or absolute timing (e.g., time in GMT, seconds). The WTRU may determine to initiate the time window after a configured duration after reception of the command (e.g., N symbols, N slots, N frames, N seconds). The WTRU may receive an activation or deactivation command (e.g., DCI, MAC-CE) to activate or deactivate the time window, respectively, from the network.

Configurations for reference signals (RSs) may be disclosed herein. The WTRU may receive DL-RS and/or UL RS (e.g., SRS) configurations for positioning purpose from the network (e.g., LMF). The LMF may forward the PRS configuration and SRS configurations to the gNB so that the gNB can schedule PRS transmission or SRS reception at the TRP, TP and/or RP.

Configurations for DL-RS may be disclosed herein. A DL-RS configuration may contain at least one of the following parameters: number of symbols, transmission power, number of DL-RS resources included in DL-RS resource set, muting pattern for DL-RS (e.g., the muting pattern may be expressed via a bitmap), periodicity, type of DL-RS (e.g., periodic, semi-persistent, or aperiodic), slot offset for periodic transmission for DL-RS, vertical shift of DL-RS pattern in the frequency domain, time gap during repetition, repetition factor, RE (resource element) offset, comb pattern, comb size, spatial relation (e.g., with respect to other DL-RSs or UL RS such as SRS for positioning purpose), QCL information (e.g., QCL target, QCL source) for DL-RS, number of TRPs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for DL-RS transmission, on/off indicator for DL-RS, TRP ID, DL-RS ID, cell ID, global cell ID, and/or applicable time window. The WTRU may apply a DL-RS configuration under a condition that the current time is within the applicable time window. “ID” may be used interchangeably with “index” herein.

Examples of DL-RS may include CSI-RS, PTRS, PRS, TRS, and/or SSB.

A UL RS or SRS configuration may include at least one of: resource ID; comb offset values, cyclic shift values; start position in the frequency domain; number of UL RS symbols; shift in the frequency domain for UL RS; frequency hopping pattern; type of UL RS (e.g., aperiodic, semi-persistent or periodic); sequence ID used to generate UL RS, or other IDs used to generate UL RS sequence; spatial relation information, indicating which reference signal (e.g., DL RS, UL RS, CSI-RS, SRS, DM-RS) or SSB (e.g., SSB ID, cell ID of the SSB) the UL RS is related to spatially where the UL RS and DL RS may be aligned spatially; QCL information (e.g., a QCL relationship between UL RS and other reference signals or SSB); QCL type (e.g., QCL type A, QCL type B, QCL type C, QCL type D); resource set ID; list of UL RS resources in the resource set; transmission power related information; pathloss reference information which may contain index for SSB, CSI-RS or DL-RS; periodicity of UL RS transmission; bandwidth; carrier component ID; and/or spatial information such as spatial direction information of UL RS transmission (e.g., beam information, angles of transmission), spatial direction information of DL RS reception (e.g., beam ID used to receive DL RS, angle of arrival). “ID” may be used interchangeably with “index” herein.

Examples of UL RS may include SRS and SRS for positioning purpose.

Positioning techniques may be disclosed herein. There may be one or more (e.g., three) categories of WTRU positioning techniques: DL positioning methods, UL positioning methods, and/or DL & UL positioning methods.

A “DL positioning method” may refer to any positioning method that uses downlink reference signals such as PRS. The WTRU may receive multiple reference signals from TP(s) and measure DL RSTD and/or RSRP. Examples of DL positioning methods include DL-AoD and DL-TDOA positioning.

A “UL positioning method” may refer to any positioning method that uses uplink reference signals such as SRS for positioning. The WTRU may transmit SRS to multiple RPs, and the RPs may measure the UL RTOA and/or RSRP. Examples of UL positioning methods may include UL-TDOA or UL-AoA positioning.

A “DL & UL positioning method” may refer to any positioning method that uses both uplink and downlink reference signals for positioning. For example, a WTRU may transmit SRS to multiple TRPs, and the gNB may measure Rx-Tx time difference, which may be calculated based on the time of arrival of DL RS (e.g., PRS). The gNB may measure RSRP for the received SRS. The WTRU may measure the Rx-Tx time difference for PRS transmitted from multiple TRPs. The WTRU may measure RSRP for the received PRS. The Rx-TX difference, and possibly RSRP measured at WTRU and gNB, may be used to compute round trip time. Here “WTRU Rx-Tx time difference” may refer to the difference between arrival time of the reference signal transmitted by the TRP and transmission time of the reference signal transmitted from the WTRU. An example of a DL & UL positioning method may be multi-RTT positioning.

Measurements may be performed. The WTRU may obtain CIR (Channel Impulse Response) from the network. The network may indicate DL-RS configuration(s) such as DL-RS resource IDs associated with the CIR. For example, the CIR may be associated with the DL-RS resource ID. The WTRU may determine that the CIR is derived based on the measurements made on the DL-RS resource associated with the ID. Alternatively, the WTRU may determine that the channel along the direction of transmission of the DL-RS or reception of the DL-RS corresponds to the CIR.

The CIR may be associated with a TRP ID. The WTRU may determine that the CIR represents the channel between the associated TRP and WTRU. The CIR may be associated with more than one TRP, where the network may include TRP indices associated with the CIR.

The CIR may be associated with a cell. The WTRU may receive a cell ID or index associated with the CIR from the network.

CIR may be associated with more than one TRP or DL-RS resource ID. The WTRU may determine that the channel between the TRPs and the WTRU corresponds to the CIR. Alternatively, the WTRU may determine that the channel along the transmission directions of DL-RSs associated with IDs or reception directions of the DL-RS correspond to the CIR.

More than one CIR may be associated with a (e.g., one) parameter from DL-RS configuration(s) (e.g., TRP ID, DL-RS resource ID, frequency layer ID). For example, the WTRU may receive information related to one or more (e.g., two) CIRs associated with a TRP from the network. The WTRU may report information related to more than one CIR associated with DL-RS configuration(s) (e.g., TRP ID, DL-RS resource ID) based on the measurements to the network. There may be more than one CIR associated with a DL-RS configuration since the WTRU or network may observe different channel characteristics based on AoA of DL RS or UL RS, for example.

Channel impulse response may be represented by DP (delay profile) or PDP (power delay profile). A power delay profile may be defined as a set of delays and power profiles, such as [τ₀, τ₁, . . . , τ_{N-1}] and [p₀, p₁, . . . , p_{N-1}], where pk may correspond to relative power at the kth path compared to the first path. A delay profile may be defined as a set of delays [τ₀, τ₁, . . . , τ_{N-1}], with respect to a reference timing (e.g., first path and/or indicated reference timing), which may indicate a path delay for a (e.g., each) path. A (e.g., each) path may have a path power above p_{threshold}. The WTRU may receive p_{threshold} from the network to derive the delay profile from the power delay profile.

The channel impulse response the WTRU reports to the network may be defined by a configured number of samples (e.g., N) where the WTRU may be configured with a granularity of samples (e.g., X seconds apart). The WTRU may report samples whose RSRP is over the configured threshold or M highest RSRP among the samples. The WTRU may indicate locations or sample index of samples where the WTRU may measure the M highest RSRP samples. The first sample may be defined as the earliest arriving path (e.g., first path). The WTRU may report timing, phase and/or power information per sample.

The WTRU may receive an indication from the network on how to generate CIR, PDP or DP based on timing, phase and/or power measurements. The WTRU may send a request to the network to receive an indication on which methodologies to use to generate CIR, PDP or DP based on the measurements the WTRU made. For example, the WTRU may receive a message from the network (e.g., via LPP, RRC, MAC-CE, DCI) indicating the DL-RS resource indices and/or associated measurement type(s) (e.g., RSTD, AOA) to use to generate CIR, PDP or DP. The WTRU may receive an indication from the network indicating to generate CIR, PDP or DP.

The WTRU may receive a threshold (e.g., power threshold) from the network and timing range (e.g., 0 μs to 1 μs), timing granularity (e.g., every 0.1 μs in the indicated timing range, 100 sample points in the indicated timing range) of CIR, PDP and/or DP. The WTRU may determine to report power and timing (e.g., relative timing compared to a reference timing, absolute timing) of one or more samples (e.g., any samples whose received power is over the threshold)

The WTRU may send measurements in a report to the network (e.g., LMF, gNB) via a semi-static (e.g., LPP, RRC) or dynamic message (e.g., UCI, UL MAC-CE).

The terms DL-RS (e.g., CSI-RS, DM-RS, TRS) and SSB may be used interchangeably herein.

A measurement or location may have contents. The WTRU may receive a request from the network to report its location and/or measurements made on the PRS. The location report may contain inference (e.g., WTRU location estimate) generated by an AIML model(s). The WTRU may report to the network one or more of the following in the measurement report: a PRS ID associated with measurements and/or WTRU location estimate; a TRP ID associated with measurements and/or WTRU location estimate; a Cell ID associated with measurements and/or WTRU location estimate; an absolute Radio-Frequency Channel Number (ARFCN) associated with measurements and/or WTRU location estimate; a PRS Resource ID(s) associated with measurements and/or WTRU location estimate; a PRS Resource Set ID(s) associated with measurements and/or WTRU location estimate; a frequency layer ID(s) associated with measurements and/or WTRU location estimate; a timestamp indicating when the measurements are made or when the report is made; an RSTD associated with PRS resource ID(s) for a (e.g., each) path in multipaths; an RSRP associated with PRS resource ID(s) for a (e.g., each) path in multipaths; a phase measurement (e.g., RSCP, RSCPD) for a (e.g., each) path in multipaths; uncertainty information (e.g., expressed in terms of a range such as ±2 μs) or quality information (e.g., indicating whether the indicated measurement is in the unit of 0.1 μs or 0.01 μs) for measurements; a TEG (timing error group) associated with measurements or PRS resource ID or PRS resource set ID; an LOS indicator associated with PRS resource ID or TRP ID; a WTRU location (e.g., absolute location with geographical coordinates expressed by x and y coordinates, relative location with respect to a reference point (e.g., indicated TRP, cell center)); uncertainty information for the determined WTRU location (e.g., expressed in terms of a range such as ±2 meter) or quality information (e.g., indicating whether the indicated WTRU location is in the unit of 0.1 meter or 0.01 meter); a timestamp indicating when inference (e.g., WTRU location estimate generated by AIML model(s)) is applicable (e.g., the timestamp may indicate where the WTRU is at the indicated timestamp); an indication of which method (e.g., RAT dependent positioning method such as DL-TDOA, DL-AoD, or AIML based positioning) is used to determine the WTRU location; assistance information, PRS configuration (e.g, PRS resource ID) or association information used to generate the reported inference; a channel impulse response and associated DL-RS configurations used to determine CIRs; and/or a model or functionality ID used to generate WTRU location estimate.

Artificial intelligence (AI) for positioning may be described. Artificial intelligence may be broadly defined as the behavior exhibited by machines that mimics cognitive functions to sense, reason, adapt, act, and providing the ability to discern patterns.

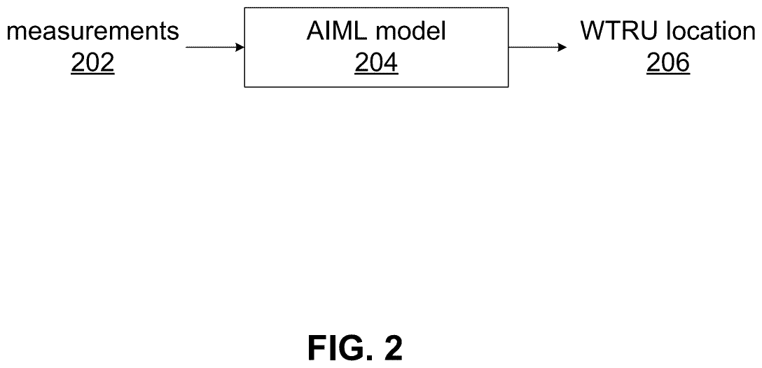

AI for positioning may use inputs and outputs. FIG. 2 illustrates an example of using an AIML model to obtain a WTRU location. As shown in FIG. 2, the WTRU may input the AIML model 204 with measurements 202 (e.g., timing, phase, power measurements such as RSTD, time of flight, ToA, ToD, carrier phase measurement, carrier phase difference measurement, RSRP, RSRP per path) and the WTRU may obtain the WTRU location 206 from the AIML model 204. The output of the AIML model 204 may be referred to as “inference.”

As an input to the AIML model 204, if the AIML model 204 is associated with or trained with measurements from more than one TRP, the WTRU may use measurements made from the more than one TRP. If the AIML model 204 is trained with measurements from more than one TRP, the WTRU may receive an indication or configuration from the network about identification information about the TRPs (e.g., TRP IDs, PRS IDs) the AIML model 204 is trained with. “AIML” and “AI/ML” may be used interchangeably herein.

Examples of inputs for an AIML model for positioning may include one or more of the following: RSRP of PRS resource(s); Statistical measure of RSRP (e.g., mean, variance etc.) per PRS resource(s); Maximum or minimum value of RSRP per PRS resource(s); RSRP of PRS resource(s) per path; RSRP of PRS resource(s) per antenna port; RSCP of PRS resource(s) per path; RSCP of PRS resource(s) per antenna port; RSTD and/or RSCPD of PRS resource(s); Statistical measure of RSTD per PRS resource(s); Maximum or minimum value of RSTD per PRS resource(s); RSTD and/or RSCPD of PRS resource(s) per path; RSTD and/or RSCPD of PRS resource(s) per antenna port; Time of arrival per PRS resource(s); Time of arrival per PRS resource(s) per path; Time of arrival per PRS resource(s) per port; Statistical measure of Time of arrival per PRS resource(s); Maximum or minimum value of time of arrival per PRS resource(s); CIR estimated based on DL-RS(s) (e.g., PRS, CSI-RS, DM-RS), where CIR may be associated with a TRP or TRPs; PDP estimated based on DL-RS(s) (e.g., PRS, CSI-RS, DM-RS), where CIR may be associated with a TRP or TRPs; and/or DP estimated based on DL-RS(s) (e.g., PRS, CSI-RS, DM-RS) where CIR may be associated with a TRP or TRPs.

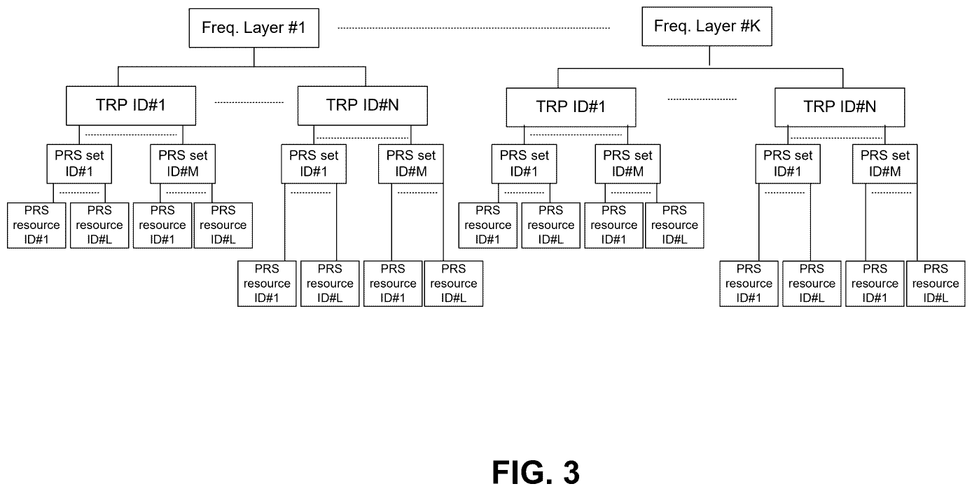

Hierarchy in PRS configurations may be disclosed herein. FIG. 3 illustrates an example of a hierarchical structure of PRS configurations. As shown in FIG. 3, PRS parameters may be organized in a hierarchical manner. Parameters associated with a higher layer may be used by parameters at lower layer(s). For example, if a frequency layer has a parameter comb factor=2, PRS resource sets, TRPs and PRS resources under the frequency layer may also use comb factor=2. The parameters may be organized in a hierarchical manner to reduce signaling overhead from the network.

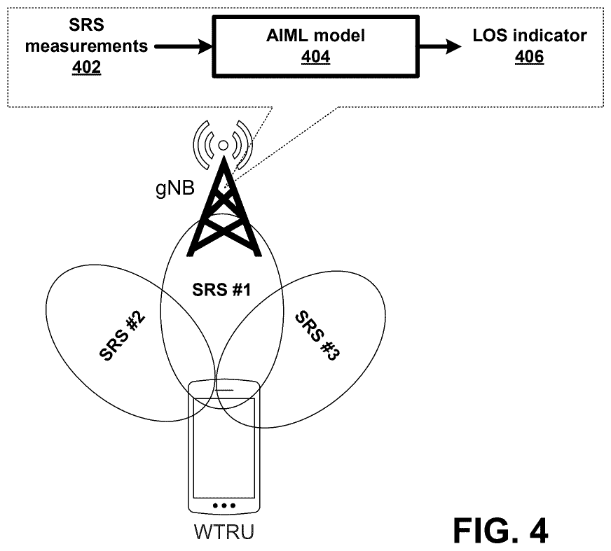

FIG. 4 illustrates an example gNB-AIML model 404 with intermediate KPIs (e.g., LOS indicator(s)) generated based on SRS measurements 402. The gNB may have an AIML model 404 that can generate one or more LOS indicators 406, as shown in FIG. 4. The AIML model 404 may be trained with measurements made from SRS received by the gNB.

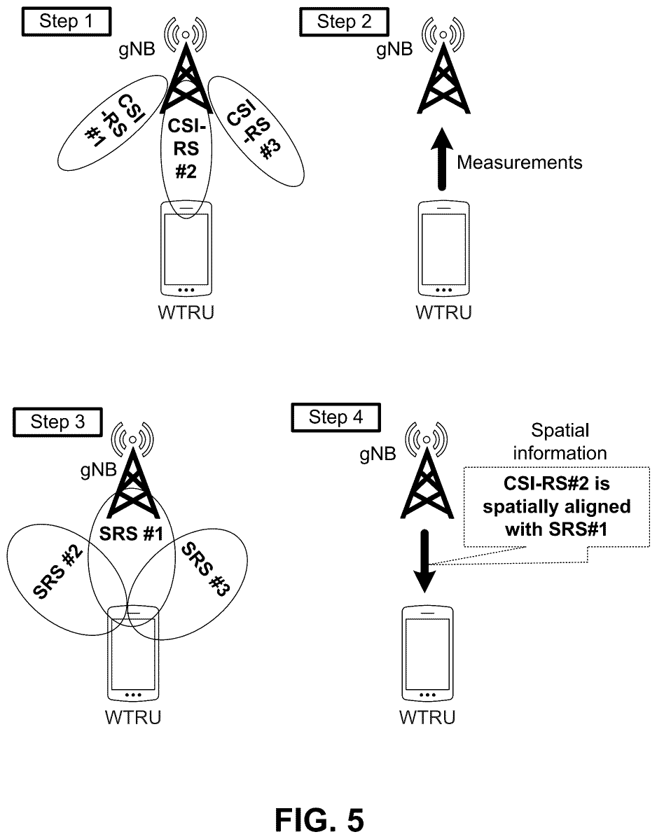

FIG. 5 illustrates an example of determination of spatial information. In the current framework, determination of spatial relation information of a WTRU may require one or more (e.g., at least four) steps, for example as shown in FIG. 5. If the WTRU rotates/moves, determination of spatial information may need to be repeated, which may increase signaling overhead. Methods for the WTRU to determine spatial information for UL transmission after the WTRU-side condition changes (e.g., rotation) may be desired.

A WTRU may send a request for a metric (e.g., an LOS indicator) for one or more indicated SRSs. The WTRU may determine a transmission spatial filter for PUSCH based on the metric associated with the SRSs.

The WTRU may receive a request to become a contributor for data collection. The WTRU may send a response to agree to become a contributor for data collection. The WTRU may receive a response from the network to confirm registration as a contributor. The WTRU may send a request for a LOS indicator for the indicated SRS (e.g., SRS resource ID). The WTRU may (e.g., additionally) indicate a TRP ID (e.g., if available at the WTRU) and/or SRS ID (e.g., SRS resource ID). The WTRU may receive, from the network, configurations to transmit SRSs (e.g., which includes the indicated SRS). The WTRU may transmit the configured SRSs. The WTRU may receive, from the network, a LOS indicator for the indicated SRS. The WTRU may receive a request to determine the transmission spatial filter based on the highest LOS indicator associated with the SRS. The WTRU may determine to associate PUSCH with the SRS with the highest LOS indicator value. The WTRU may determine spatial association based on the destination TRP (e.g., the indicated TRP) and LOS indicator.

Obtaining assistance data for UL transmission may be disclosed herein. One or more AIML functionalities may be disclosed herein. For example, there may be one or more AIML functionalities at the gNB. An AIML functionality may be one or more of the following.

An AIML functionality may define what a gNB can do with the AIML functionality (e.g., AIML based positioning). The AIML functionality may indicate characteristics of input and/or output of an AIML model. The AIML functionality may indicate type(s) of measurements the AIML model(s) can accept. The AIML functionality may indicate validity conditions for inference generated by the AIML model(s). The AIML functionality may indicate a validity condition for the AIML model(s). The AIML functionality may indicate type(s) of inference the AIML model(s) may generate (e.g., WTRU location, intermediate metric such as LOS indicator, measurement). The AIML functionality may indicate capabilities of the AIML model(s) (e.g., latency required to generate inference, the number of inputs, memory size, computational complexity, etc.).

For example, an AIML functionality may be AIML-based positioning. If the gNB indicates the AIML-based positioning as a supportable AIML functionality, it may indicate that the gNB may have an AIML model(s) that is capable of performing AIML-based positioning.

The gNB may indicate that the supportable AIML functionality is BW aggregation-based AIML-based positioning. This may indicate that the gNB has an AIML model that can accept measurements made based on BW aggregation. The gNB may indicate that the supportable AIML functionality is PDP-based AIML-based positioning. This may indicate that the AIML model the gNB has can accept PDP as its inputs.

The gNB may indicate the supportable AIML functionality is AIML-based positioning with indicated maximum synchronization error. This may indicate that the WTRU may have AIML model(s) that can tolerate timing error or network synchronization error up to the indicated maximum synchronization error.

Some tolerance in difference in assistance information and/or SRS configuration between training and inference may be allowed. For example, assistance information used by the gNB to train an AIML model may be different from assistance information the gNB receives from the LMF when the gNB is requested to generate inference based on the trained AIML model by the WTRU or LMF. For example, network synchronization error may be different by a few tenths of a micro-second between the training phase and inference phase, and such difference may not affect inference performance. The gNB may be preconfigured or configured with tolerance difference in assistance information between training and inference phase. If the difference is above the tolerable difference (e.g., above a threshold amount), the gNB may determine to use the fallback positioning method or report to the network that the gNB cannot perform AIML based positioning due to the difference. SRS configurations and/or assistance information may be the same. For example, between training and inference phase, SRS configuration parameters such as Frequency Layer ID, TRP IDs or Cell IDs may (e.g., need to) be the same for the AIML model to be valid.

The gNB may indicate that a supportable AIML functionality can accept N PDPs, where a (e.g., each) PDP may be generated based on PRSs received from TRPs.

The gNB may indicate that the supportable AIML functionality is area-based AIML-based positioning. This may indicate that the gNB is able to perform positioning with an AIML model(s) which can generate inference (e.g., WTRU location) in the area associated with the AIML model(s).

The gNB may indicate that the support for an AIML functionality with which AIML based positioning can be achieved during an INACTIVE mode. During the INACTIVE mode, the WTRU may start monitoring signals or making measurements on DL-RSs when the WTRU receives a trigger from the network. Otherwise, the WTRU may not make measurements or transmit signals during the INACTVE mode to save power.

Identification of a functionality may be performed. In an AIML-based positioning method, the gNB may use AIML model(s) to obtain a WTRU location. The input of the AIML model(s) may be based on the measurements made on the received UL RS. The UL RS may be received by the gNB and/or processed by an AIML model training server.

A UL RS configuration may identify an AIML functionality. For example, if the UL RS configuration indicates frequency layer aggregation, it may imply that the gNB needs to use AIML model(s) that can accept measurements made from aggregated frequency layers as AIML inputs.

NW-side conditions may identify an AIML functionality. For example, if the NW assistance information indicates that there is a large synchronization error between TRPs or gNBs, the LMF may indicate that the gNB shall use an AIML model(s) that is trained based on a similar condition (e.g., trained with data which is generated at the same or similar range of synchronization error).

An AIML functionality may be indicated by assistance information provided by the network (e.g., associated ID).

The gNB may determine an AIML functionality based on the content of a request sent by the WTRU. For example, the network may send a request to perform positioning or AIML based positioning using an indicated set of measurements (e.g., PDP, timing, power, phase, angle measurements, etc.). The WTRU may receive a request to report measurements or WTRU location to the network. Based on the request about measurements and report content, the gNB may determine an AIML functionality that can accept the requested measurements and yield the requested report content (e.g., WTRU location). The request may contain an explicit indication of which functionality to use (e.g., via functionality ID).

An AIML functionality may be defined by input type and/or output type. For example, for a functionality ID #1 (e.g., a first functionality), an input type may be PDP and an output type may be a WTRU location. For functionality ID #2 (e.g., a second functionality), an input type may be DP and an output type may be DP.

The gNB may determine an AIML functionality based on a configured positioning method. For example, the gNB may be configured with a timing-based positioning method (e.g., UL-TDOA) and the gNB may receive, from the network, an indication to use an AIML model to determine the WTRU location. Based on the configured positioning method and assistance information, the gNB may determine the AIML functionality (e.g., which AIML model(s) to use for positioning). In another example, the gNB may receive a configuration for an AIML-based positioning method and based on the configured positioning method, the gNB may determine the AIML functionality.

An AIML functionality may be enabled. The gNB may receive a request for inference from the WTRU which may trigger the inference phase. The WTRU may also receive association information and UL RS configuration from the LMF. Based on the association information and UL RS configuration received from the LMF, the gNB may determine to generate inference and report the inference to the network.

Registration of a WTRU as a contributor for an AI/ML system may be performed.

The WTRU may register with the network indicating its capabilities for the transmission of configured SRSs to the gNB. The WTRU may indicate that it wishes to receive superior or supplemental assistance data from the gNB for enhanced data communication or position purposes (e.g., in exchange of WTRU providing training data for the gNB's AIML model). An example of supplemental assistance data may be measurements or assistance data (e.g., LOS indicator) determined by the network based on UL RS transmitted by the WTRU. The purpose of the registration may to be recognize the WTRU as a potential contributor for data collection based on the UL transmission. By registering, the WTRU may be able to send a request for assistance data which is not available for the WTRUs which are not registered as a contributor for data collection. The WTRU receives a registration response from the network with acceptance of gNB providing superior or supplemental assistance data.

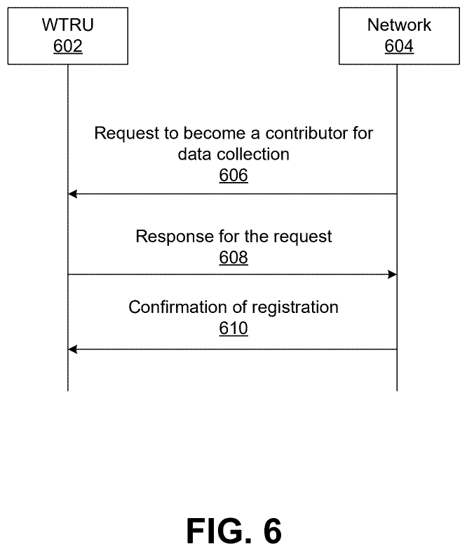

The WTRU may receive a request from the network for the WTRU to register itself as a contributor for data collection. The WTRU may send a response for the request, e.g., “yes” or “no”. The WTRU may send WTRU capability information to the network (e.g., indicating that the WTRU can transmit SRS). FIG. 6 illustrates an example of a call flow between a network 604 and a WTRU 602 to become a contributor for data collection. As shown in FIG. 6, the WTRU 602 may receive a request from the network 604 to become a contributor for data collection at 606, and the WTRU 602 may respond to the request at 608. If the WTRU 602 agrees to become a contributor, the WTRU 602 may receive a message from the network 604 to confirm that the WTRU 602 is registered as a contributor at 610. The WTRU 602 may receive information related to registration (e.g., registration ID).

The WTRU may send a request to the network requesting that the WTRU become a contributor for data collection.

The WTRU subscription data (e.g., in UDM/UDR) may include an indication that WTRU is SRS transmission capable. The subscription data may include an indication that the WTRU is allowed as a contributor for configured SRS transmission. The WTRU may receive a network configuration message (e.g., in WTRU Configuration Update procedure) confirming acceptance of the WTRU to act as a contributor WTRU.

During one or more of the procedures described herein, the gNB may receive from the network (e.g., AMF, AI/ML data collection function) an indication indicating the WTRU as a contributing WTRU. Based on the indication, the gNB may determine to enable superior or supplemental assistance information to the WTRU.

The WTRU may send a message to the gNB including an indication about its SRS transmission capabilities. The WTRU may provide an indication for its availability as an SRS contributor. The gNB may send a request message to the network to check for authorization for providing superior or supplemental assistance information. Based on received response message from the network, the gNB may determine to enable superior or supplemental assistance data for the WTRU.

The terms “assistance data,” “superior assistance data,” and “supplementary assistance data” may be used interchangeably herein.

WTRU behavior during data collection (SRS transmission) may be disclosed herein.

The WTRU may transmit SRS for training the AIML model at the gNB. The WTRU may receive a request from the network indicating the cause for the request, e.g., for training an AIML model(s) at the network (e.g., gNB), for training a NW-side AIML model(s) that can output intermediate KPIs such as a LOS indicator. The WTRU may be configured, by the network, with a set of SRS and associated configurations (e.g., periodicity, spatial information, transmission power).

The WTRU may receive a request from the network to start transmission of the configured SRS. The WTRU may receive a request from the network to stop transmission of the configured SRS. In another example, the WTRU may receive a configuration for a time window during which the WTRU transmits the configured SRS.

Training for DL may be disclosed. Configurations may be used.

A WTRU may receive a configuration of one or more of the following for training: one or more DL RS resources for signal prediction (e.g., in a second RS resource set/resource config e.g., Set A); one or more DL RS resources for signal measurement (e.g., in a first RS resource set/resource config e.g., Set B); and/or a reporting configuration.

A WTRU may receive a configuration of one or more DL RS resources for signal prediction (e.g., in a second RS resource set/resource config e.g., Set A) for training. For example, one or more CSI-RS resources (e.g., for BM) and/or SSBs may be configured for signal prediction. A number of the one or more RS resources for signal prediction may be larger than the one or more RS resources for signal measurement.

A WTRU may receive a configuration of one or more DL RS resources for signal measurement (e.g., in a first RS resource set/resource config e.g., Set B) for training. For example, one or more CSI-RS resources (e.g., for BM) and/or SSBs may be configured for signal measurement. The one or more CSI-RS resources for signal measurement may not be configured if the one or more CSI-RS resources for signal measurement is a subset of the one or more CSI-RS resources for signal prediction.

A WTRU may receive one or more reporting configurations for training. For example, the WTRU may be configured with reporting configuration for beam/signal/interference measurement and prediction. For the reporting configuration, the WTRU may be configured with a number of beams/resources to be reported. The configuration may be separately configured for signal and interference, respectively. For example, the WTRU may be configured with K beams/resources for signal and/or L beams/resources for interference, respectively.

Measurement and determination of quality may be performed. The WTRU may measure the one or more RS resources for signal measurement and/or the one or more RS resources for signal prediction.

The WTRU may determine qualities for the one or more RS resources for signal measurement and/or the one or more RS resources for signal prediction. The qualities may be one or more of RSRP, SINR, CQI, hypothetical BLER, etc.

The WTRU may report the determined qualities (e.g., to a gNB) (e.g., for training of a gNB model). For example, the WTRU may indicate a best beam (e.g., by using CRI/SSBRI), an absolute RSRP for the best beam, and differential RSRPs for the beams other than the best beam.

Training for UL may be disclosed. Configurations may be used.

A WTRU may receive a configuration of one or more of the following for training: one or more RS resources for signal prediction (e.g., in a second UL RS resource set e.g., Set A); and/or one or more RS resources for signal measurement (e.g., in a first UL RS resource set e.g., Set B).

A WTRU may receive a configuration of one or more RS resources for signal prediction (e.g., in a second UL RS resource set e.g., Set A) for training. For example, one or more SRS resources (e.g., for BM) may be configured for signal prediction. A number of the one or more SRS resources for signal prediction may be larger than the one or more SRS resources for signal measurement.

A WTRU may receive a configuration of one or more RS resources for signal measurement (e.g., in a first UL RS resource set e.g., Set B) for training. For example, one or more SRS resources (e.g., for BM) may be configured for signal measurement. The one or more SRS resources for signal measurement may not be configured if the one or more SRS resources for signal measurement is a subset of the one or more SRS resources for signal prediction.

Transmission may be performed. The WTRU may transmit one or more SRS resources for Set A and/or Set B to a gNB (e.g., for training). The one or more SRS resources may be one or more of periodic, semi-persistent and aperiodic. In case of periodic, the WTRU may transmit the one or more SRS resources for Set A and/or Set B based on configured periodicity and offset. In case of semi-persistent, the WTRU may transmit the one or more SRS resources for Set A and/or Set B based on configured periodicity and offset when the one or more SRS resources for Set A and/or Set B are activated (e.g., via MAC CE). In case of aperiodic, the WTRU may transmit the one or more SRS resources for Set A and/or Set B based on a trigger (e.g., via DCI).

A change in WTRU-side conditions and examples of WTRU-side conditions may be disclosed herein.

The WTRU may determine to request assistance data from the network or determine metrics associated with the SRSs based on a change in WTRU-side conditions.

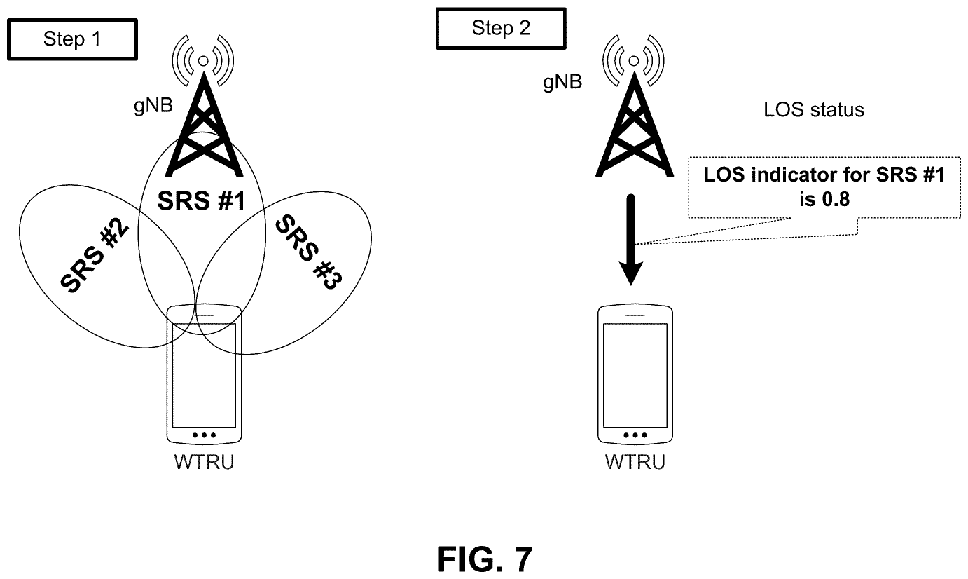

An example of assistance data may be an LOS indicator. FIG. 7 illustrates an example LOS indicator for SRS. As shown in FIG. 7, The WTRU may request an LOS indicator for a first SRS (e.g., SRS #1), and the WTRU may be configured to transmit the first SRS (e.g., SRS #1), a second SRS (e.g., SRS #2), and a third SRS (e.g., SRS #3).

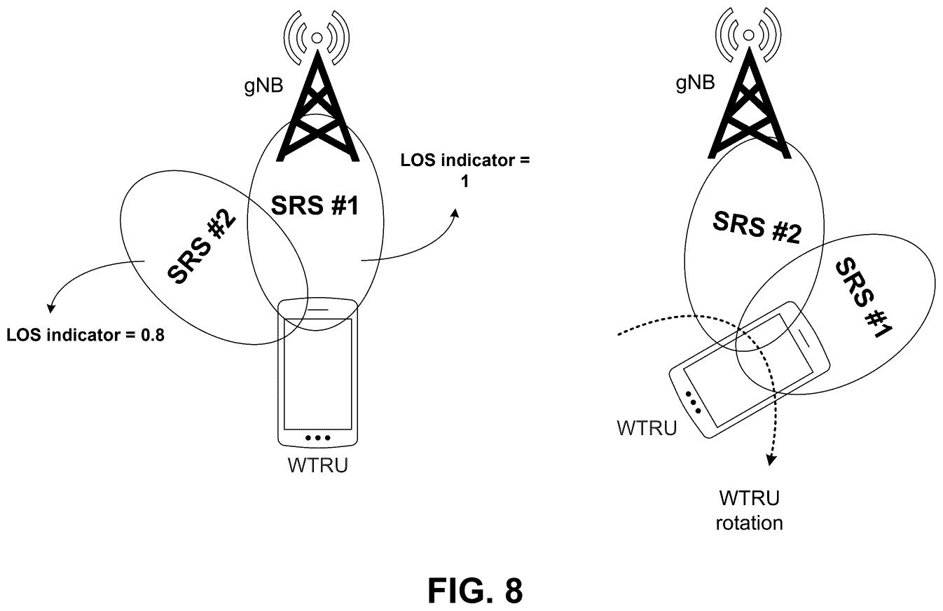

The WTRU may receive an LOS indicator for the first SRS (e.g., SRS #1), where the value of the indicator may be 0.8. Based on the received LOS indicator, the WTRU may be able to determine the LOS indicator for a (e.g., each) SRS after the WTRU-side condition changes. FIG. 8 illustrates an example of using an LOS indicator value for each SRS to determine the optimal beam for UL transmission when the WTRU condition (e.g., rotation) changes. As shown in FIG. 8, LOS indicators associated with SRS #1 and SRS #2 may be 1 and 0.8, respectively, prior to a WTRU rotation (e.g., at a first time). After the WTRU rotates (e.g., at a second time), the WTRU may determine the LOS indicators for SRS #1 and SRS #2 based on the LOS indicators received prior to the WTRU rotation.

Examples of WTRU-side conditions include, but are not limited to, the following: an orientation of the WTRU; a location of the WTRU; a change in WTRU mobility; hardware (e.g., Tx or Rx panel, amplifiers, filters) used by the WTRU; a hardware condition or status (e.g., orientation of a panel); hardware or software; a time synchronization source (e.g., clock information from GNSS, clock information from the gNB); an absolute or relative location of Tx or Rx panels; a time synchronization error at the WTRU (e.g., timing drift, timing jitter); an AoA or AoD alignment error at the WTRU; a phase alignment error at the WTRU; and/or beamforming techniques (e.g., analog, digital).

The WTRU may be configured with a reference time with respect to which the WTRU determines the change in the condition. For example, the WTRU may determine to monitor the WTRU side condition periodically. The WTRU may determine a change in WTRU-side condition with respect to the previous monitoring occasion. The WTRU may determine to check the WTRU-side condition at a previous transmission (e.g., transmission of PUSCH) or measurement (e.g., measurement of DL-RS) occasion.

A WTRU request may include one or more details. For example, the WTRU may request assistance data and/or one or more metrics.

The WTRU may send a request for assistance data or metric(s) associated with a UL RS. A type of assistance data or metrics may include one or more of the following: an LOS indicator; a measured RSRP, SINR, and/or SNR; measurements such as CIR, power delay profile (PDP), and/or delay profile (DP); a predicted RSRP, SINR, and/or SNR (e.g., the WTRU may receive information on predicted quality of SRS resources (e.g., in Set A)); a prediction accuracy and/or probability; and/or one or more predicted best beams (e.g., by indicating SRS resources) (e.g., in the future time instances). For prediction accuracy and/or probability, the WTRU may receive information on prediction accuracy/probability. The prediction accuracy may be common for (e.g., all of) the other information (e.g., all the SRS resources). Alternatively, the prediction accuracy may be beam specific (e.g., for each SRS resource). For predicted best beams, the WTRU may receive information on predicted best beams (e.g., at the gNB side).

The WTRU may request assistance data or metrics for a specific UL RS. The WTRU may determine to request assistance data or a metric (e.g., LOS indicator) for indicated UL RSs (e.g., SRS). The WTRU may send a set of identification of SRSs (e.g., SRS resource IDs, SRS IDs). The WTRU may be configured by the network with the first set of SRSs, and the WTRU may request assistance data for the second set of SRSs, which may be a subset of the first set of SRSs. The WTRU may receive a request, from the network, to transmit the indicated SRSs, which may include the second set of SRSs. The first set of SRSs may be configured for communication and/or data collection purpose(s).

The WTRU may determine to send a request to the network for assistance data or metric for indicated UL RSs if the WTRU is registered as a contributor for data collection. The WTRU may transmit information related to the registration (e.g., registration ID) to the network.

The WTRU may indicate the first set of SRSs (e.g., via an SRS resource ID) for which the WTRU desires to obtain assistance data or metric(s) (e.g., LOS indicator). The WTRU may receive SRS configurations from the network for the second set of SRSs. The first set of SRSs may be a subset of the second set of SRSs. The second set and first set of SRSs may overlap (e.g., overlapping SRS resource IDs). The first and second set of SRSs may be mutually exclusive. For example, the WTRU may request an LOS indicator for a first SRS (e.g., SRS resource ID #1). The WTRU may be configured to transmit a set of SRS resource IDs which do not include the SRS resource ID #1, where the configured the set may correspond to SRSs that are similar in terms of AoD with respect to the SRS with resource ID #1.

The WTRU may associate the assistance data with a set of DL-RS configurations. For example, the WTRU may send a request for the LOS indicator for the indicated SRS resource ID and TRP ID. In such a request, the WTRU may want to know the LOS indicator along the transmission direction of SRS and the indicated TRP.

The WTRU may indicate in the request the desired type of assistance data (e.g., RSRP, SINR, SNR) for the SRS and timestamp, where the timestamp may indicate a future time. In such request, the WTRU may want to know the predicted RSRP for the SRS at the indicated time.

The WTRU may indicate to the network to provide a transmission spatial filter for the WTRU. As a response, the WTRU may obtain the predicted best beam from the network, where the predicted best beam may indicate identification of SRS (e.g., SRS resource ID).

The WTRU may include a threshold value in the request, and may request for SRSs associated with assistance data or metrics above the threshold. For example, the WTRU may include a threshold value of “0.6” in the request for a LOS indicator, and may request from the network SRS configurations (e.g., SRS resource IDs) associated with the LOS indicator above 0.6.

The WTRU may receive a set of SRS configurations for which the WTRU may request a metric or assistance data. The WTRU may receive the set of SRS configurations after the network indicates that the WTRU is registered as a contributor for data collection. In another example, the WTRU may determine to send a request for a metric if the WTRU receives a confirmation from the network that the WTRU is registered as a contributor for data collection.

Based on the change in the WTRU-side condition, the WTRU may send a request to the network for UL resources and to get assistance data or metrics for the requested UL resources. For example, if the WTRU determines that the WTRU-side condition changed (e.g., the WTRU rotated), the WTRU may determine to send a request to the network for a metric or assistance data for the indicated SRSs.

What the WTRU requests may depend on DL-RSs measured by the WTRU.

The WTRU may determine to send a request for a metric or assistance data for the indicated UL RS from the network if the WTRU reports measurements for the configured DL RS. The WTRU may be configured to make measurements on the configured DL-RS for the indicated purpose (e.g., signal prediction). The WTRU may request a metric or assistance data that is associated with the purpose of measurements for the DL-RS. The WTRU may determine to request for a metric or assistance data for the UL RS where the requested metric or assistance data is associated with type(s) of measurement(s) made on the DL-RS. For example, the WTRU may request a predicted RSRP for the indicated UL RS if the WTRU made RSRP measurements on the received or configured DL-RS. The WTRU may request hypothetical BLER for the indicated UL RS if the WTRU determined BLER for the received or configured DL-RS.

The WTRU may determine to send a request to the network for a metric or assistance data for the indicated UL RS if the UL RS is related to DL-RSs on which the WTRU made measurements. For example, the UL RS may be related to DL-RSs spatially. Such relationship may be indicated in a configuration parameter, such as spatial relationship information.

Validity conditions for assistance data or metrics may be disclosed herein. The WTRU may receive validity conditions for assistance data and/or metrics associated with a SRS (e.g., SRS resource ID). Examples of the validity conditions may include, but are not limited to, time validity and/or area validity. For time validity, the WTRU may be configured with a metric (e.g., LOS indicator) with an SRS (e.g., SRS resource ID) with a time validity condition (e.g., expiry time). Time validity conditions may be expressed in terms of seconds, number of frames, sub-frames, symbols or slots. For area validity, the WTRU may be configured with a metric for a SRS with area validity conditions. The area validity conditions may be expressed in location (e.g., absolute or relative location with respect to a reference point), geographical area (e.g., boundary is expressed with geographical coordinates), cell(s) with cell ID(s), area ID, and/or zone ID.

A WTRU may ask a gNB whether it is feasible to provide assistance data for UL RS. The WTRU may determine to inquire the network (e.g., gNB) whether the network can provide a metric or assistance data for the UL RS indicated by the WTRU. The WTRU may obtain a response from the network for the inquiry. The WTRU may receive, via broadcast message (e.g., SIB) from the network, that the network (e.g., gNB) can provide assistance data or metric for SRS. The WTRU may receive a message from the network, indicating that AIML model(s) at the network are ready to generate indicated metrics (e.g., LOS indicators).

The WTRU may include a cause for the request. Examples of the cause may include, for example: for determination of transmission spatial filter for UL channels (e.g., PUSCH, PUCCH); for determination of environment surrounding the WTRU; and/or for updating and/or calibrating a transmission spatial filter.

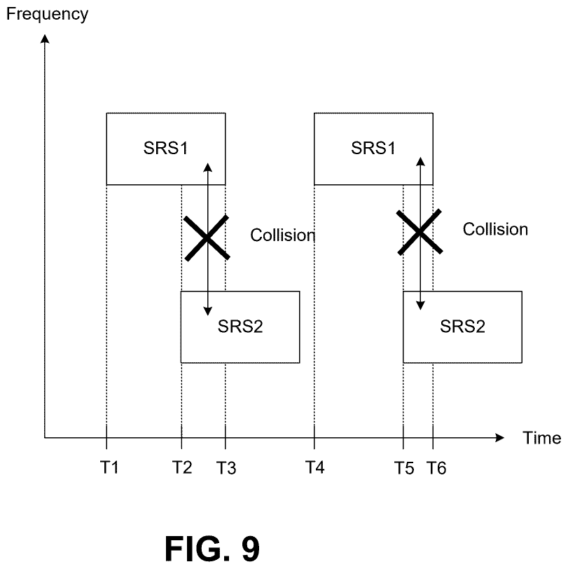

Network-triggered requests may be disclosed herein. The WTRU may receive a request from the network to transmit indicated SRSs. If the WTRU accepts the request, the WTRU may transmit the indicated SRSs to the network. The WTRU may receive an indication from the network of the purpose of SRS transmission (e.g., for training AIML models, for generation of LOS indicators, etc.). Depending on the purpose of SRS transmission, the WTRU may determine to prioritize transmission of SRS. For example, if the time frequency resources for transmission of SRS for communication purpose collide with time frequency resources for transmission of SRS for training purpose, the WTRU may determine to drop transmission of SRS for communication purpose (e.g., or to drop transmission of SRS for training purpose). A collision between two RSs may be defined as overlapping symbols and/or frequency resources of two RSs. FIG. 9 illustrates an example of collision between two SRSs. For example, as shown in FIG. 9, two SRSs (e.g., SRS1 and SRS2) which are scheduled to be transmitted may periodically collide in the time domain. In the example shown in FIG. 9, collision may occur at two instances, namely between t=T2 and t=T3, and t=T5 and t=T6. In such a case, the WTRU may (e.g., need to) determine which SRS to drop. The WTRU may determine to drop one or more SRSs at least according to the following: full dropping and/or partial dropping.

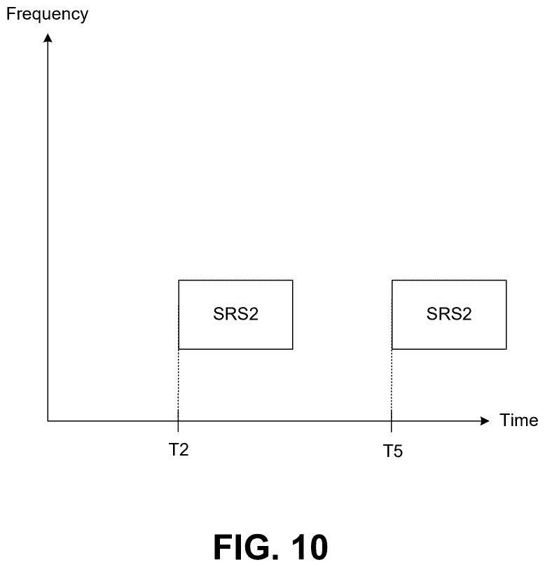

The WTRU may determine to drop one or more SRSs according to full dropping. For example, the WTRU may drop a group of SRS resources with lower priority if there is a collision between SRSs at different priority levels (e.g., SRS for AIML training purpose has higher priority compared to SRS for communication purpose). FIG. 10 illustrates an example of collision avoidance. In the example shown in FIG. 10, the WTRU may determine to drop an SRS with lower priority (e.g., SRS1), and determine to transmit an SRS (e.g., SRS2) which has a higher priority compared to SRS1.

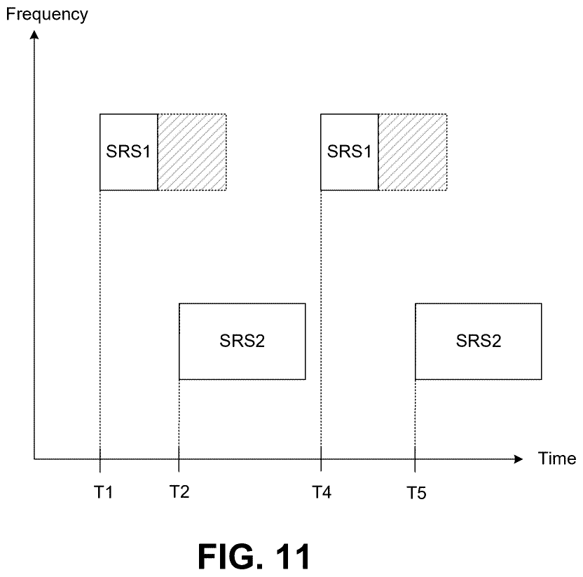

The WTRU may determine to drop one or more SRSs according to partial dropping. For example, the WTRU may drop SRS resources at lower priority that overlap with SRS resources at higher priority. FIG. 11 illustrates an example of partial dropping. As shown in FIG. 11, the WTRU may determine to drop symbols in SRS1 between t=T2 and t=T3, and t=T5 and t=T6. The WTRU may drop a configured number of symbols in SRS1 prior to t=T2 and t=T5 to allow the WTRU to switch the frequency of transmission between SRS1 and SRS2.

Timestamping WTRU conditions may occur. The WTRU may receive a request from the network to associate a timestamp based on a trigger condition. The WTRU may be configured to associate a timestamp with an SRS configuration (e.g., SRS resource ID). The WTRU may receive a request from the network to associate a timestamp for indicated SRSs (e.g., a subset of SRSs out of the configured SRSs).

The WTRU may determine to associate a timestamp with a SRS configuration if the WTRU-side condition changes. A trigger condition for associating a timestamp with an SRS configuration may be at least one of the following: a change in orientation of the WTRU is greater than a configured threshold; a change in location of the WTRU is greater than a configured threshold; a change in WTRU mobility (e.g., velocity) is greater than a configured threshold; a hardware condition or status changes; hardware or software changes occur; a synchronization source for timing changes; a location of a Tx or Rx panel changes; and/or changes in phase alignment are greater than a configured threshold.

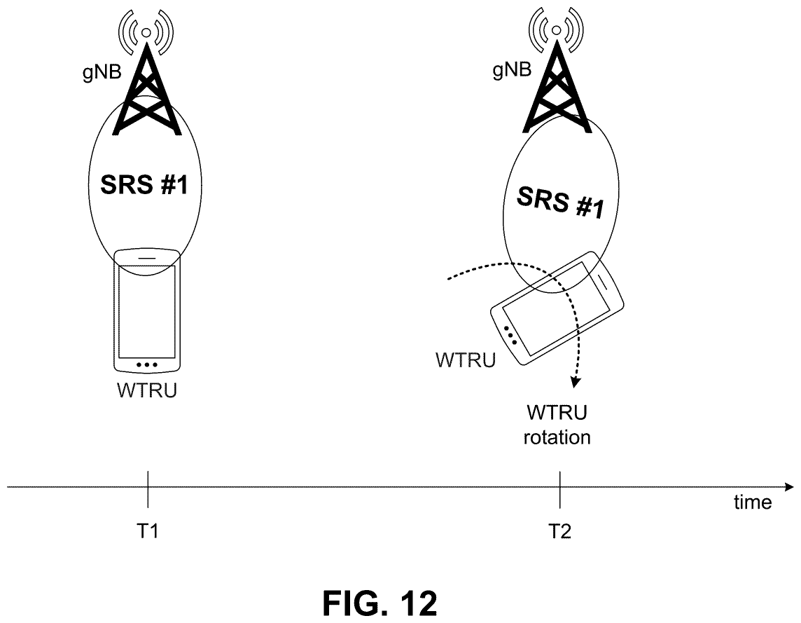

FIG. 12 illustrates an example of association of SRS configuration and a WTRU-side condition. In the example shown in FIG. 12, the WTRU may have a first orientation at a first time (e.g., t=T1), and may rotate at a second time (e.g., t=T2). The WTRU may determine to associate a timestamp with the WTRU condition at t=T2. The WTRU may also determine to associate SRS configuration with the timestamp at t=T2.

The WTRU may report the timestamp and associated SRS configuration (e.g., SRS ID, SRS resource ID) to the network. The WTRU may determine to report the SRS configuration and associated timestamp when a trigger condition (e.g., change in orientation of the WTRU is greater than the configured threshold) is satisfied. Examples of the trigger conditions may include, but are not limited to, the following: a change in a WTRU-side condition; and/or if the WTRU receives a request from the network to report association between an indicated set of UL RSs and UL channel based on the metrics given by the network. For example, the WTRU may receive metrics (e.g., LOS indicator) for a set of UL RSs from the network. The WTRU may receive a request to associate an (e.g., one of the) UL RS(s) from the set with a UL channel (e.g., PUSCH).

The WTRU may receive a request to report the SRS configuration and associated timestamp. The WTRU may indicate the transmission spatial filter used to transmit the configured SRS to the network. The WTRU may indicate a DL-RS resource ID or SRS resource ID to indicate the spatial filter used to transmit the SRS. The WTRU may also report the timestamp associated with the spatial filter to the network.

The WTRU may determine to associate a timestamp with a UL RS ID (e.g., an ID of the UL RS the WTRU is configured to transmit) when the WTRU-side condition changes (e.g., the WTRU rotates).

The WTRU may receive a request from the network (e.g., LMF, gNB) to use the spatial filter used to transmit SRS at the indicated timestamp. The WTRU may receive a DL or UL resource ID along with the timestamp in the request, indicating to use the transmission spatial filter used to transmit the indicated UL RS resource ID at the timestamp, for example.

The WTRU may receive a request from the network containing the first UL RS ID (e.g., resource ID) and second UL RS ID associated with the timestamp. The WTRU may be requested, by the network, to use the spatial filter, used to transmit the second UL RS ID at the indicated timestamp, for transmission of the first UL ID.

The WTRU may send a response for the request from the network by replying “yes” or “no” for the request. In the embodiments described herein, the timestamp may be interchangeably used with an ID or index. Instead of the timestamp, the WTRU may determine to associate an index with UL RS ID and report the index and associated UL RS ID.

The WTRU may be configured with a time window during which the WTRU may determine to associate a timestamp with a UL RS ID.

WTRU actions with acquired assistance data may be disclosed herein. A WTRU may autonomously determine a spatial filter for UL channels.

The WTRU may be configured to determine a spatial filter to transmit UL channels (e.g., PUSCH) or UL RS (e.g., SRS) based on a metric or assistance data associated with UL RS. The spatial filter used for transmission of UL channels or UL RS may determine the angle of departure. The WTRU may be configured to associate the uplink transmission spatial filter of PUSCH with that of UL RS with the highest beam quality (e.g., LOS indicator). The WTRU may report, to the network, the determined association between the uplink transmission spatial filter of UL channels (e.g., PUSCH) and UL RS (e.g., SRS) so the network can receive and process PUSCH or SRS accordingly. The WTRU may report association between UL channel and UL RS before transmitting the UL channel. The WTRU may receive a request, from the network, to report association between UL channels and UL RS. The WTRU may receive a request from the network to report identification information of SRS (e.g., SRS resource ID) associated with uplink channels or uplink reference signals. The WTRU may receive conditions (e.g., change in WTRU-side conditions) that shall be satisfied to report the association information. The WTRU may determine to report the association information (e.g., between SRS and PUCCH) when there is a change in association between SRS and uplink channels or uplink reference signals.

The WTRU may be configured, by the network, to determine an association between UL channels and UL RS based on a metric or assistance data if a trigger condition is satisfied (e.g., WTRU-side condition changed). For example, the WTRU may ask for metrics for indicated UL RS. The WTRU may receive a request from the network to transmit the indicated UL RS. The WTRU may receive, from the network, a metric (e.g., LOS indicator) for each transmitted SRS. The WTRU may determine that after the WTRU rotates by an amount that is more than a configured threshold, the spatial filter needs to be readjusted. The WTRU may determine to associate the UL channel and UL RS based on the metric (e.g., LOS indicator) associated with UL RS. The WTRU may report the SRS resource ID associated with PUSCH.

A WTRU may report an autonomously determined spatial filter. If there is a change in association between a UL channel and UL RS, the WTRU may determine to report the updated association between the UL channel and UL RS. For example, the WTRU may determine to associate PUSCH with a first SRS (e.g., SRS #1) indicating that the transmission spatial filter used to transmit SRS #1 is used to transmit PUSCH. After the WTRU experiences rotation, the WTRU may determine to associate PUSCH with a second SRS (e.g., SRS #2). The WTRU may determine to report to the network that PUSCH is now associated with SRS #2. The WTRU may include a cause for the change in the association (e.g., WTRU movement, WTRU rotation). The WTRU may send a report and/or indication to the network in a semi-static message (e.g., RRC, LPP) or dynamic message (e.g., UCI, MAC-CE).

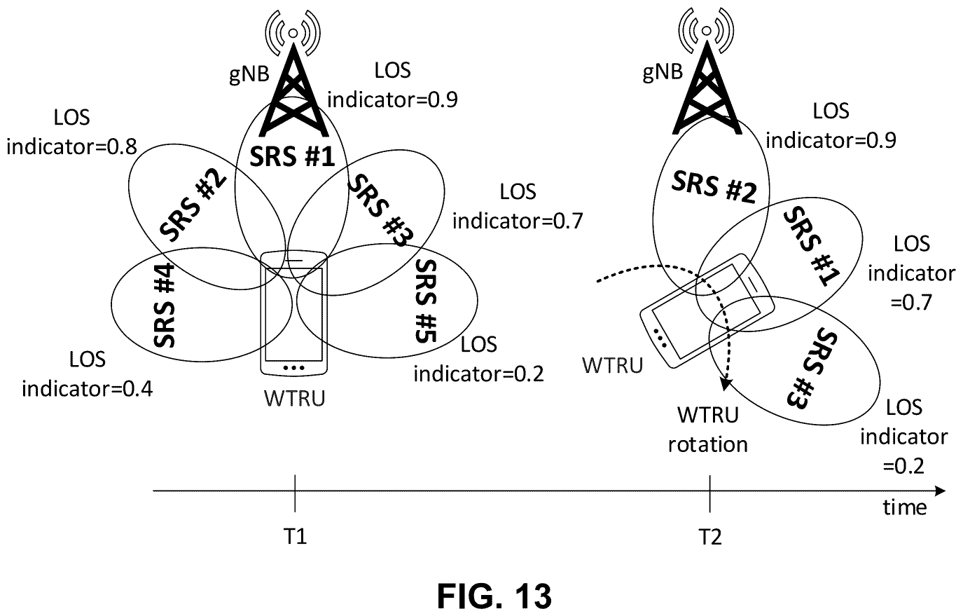

The WTRU may autonomously determine one or more metrics or assistance data. The WTRU may determine updated metrics based on the configured metrics. The WTRU may determine to update the metrics based on a trigger condition (e.g., WTRU-side condition changes). The WTRU may report the updated metric(s) to the network along with the associated UL RS and uplink channel. FIG. 13 illustrates an example of a WTRU's determination of a metric associated with SRS after the WTRU-side condition changes. As shown in FIG. 13, at a first time (e.g., t=T1), the WTRU may be configured with LOS indicators for one or more SRSs (e.g., SRS #1, SRS #2, SRS #3, SRS #4 and SRS #5), where the LOS indicator may have respective values for a (e.g., each) SRS (e.g., 0.9, 0.8, 0.7, 0.4 and 0.2, respectively). The WTRU may determine to associate SRS #1 with the spatial filter for PUCCH or PUSCH, since SRS #1 has the highest LOS indicator among the SRSs with the LOS indicator. At a second time (e.g., t=T2), the condition of the WTRU may change. The WTRU may determine to update the LOS indicator associated with the SRS, such that the LOS indicators associated with SRS #1, SRS #2 and SRS #3 are 0.7, 0.9 and 0.2, respectively. The WTRU may determine to associate SRS #2 with PUSCH and PUCCH based since SRS #2 has the highest LOS indicator. The WTRU may use the spatial filter used to transmit SRS #2 to transmit PUSCH or PUCCH.

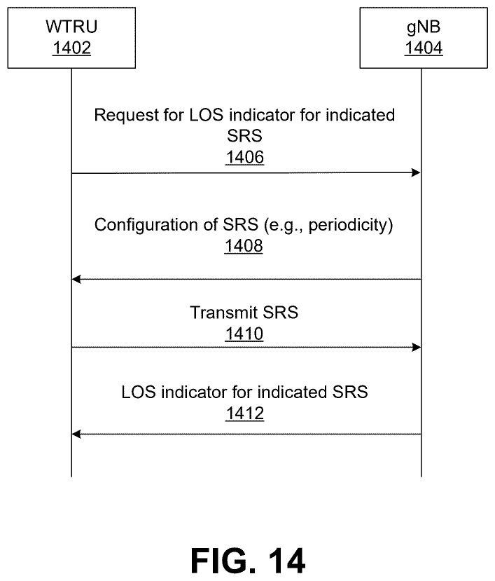

FIG. 14 illustrates an example call flow between a WTRU 1402 and a gNB 1404. As shown in FIG. 14, the WTRU 1402 may send a request to the gNB 1404 for a LOS indicator for indicated one or more SRSs at 1406. The WTRU 1402 may receive SRS configurations from the gNB 1404 at 1408. The WTRU 1402 may transmit the configured SRS to the network 1404 at 1410. The WTRU 1402 may receive a LOS indicator from the gNB 1404 for the indicated SRSs at 1412.

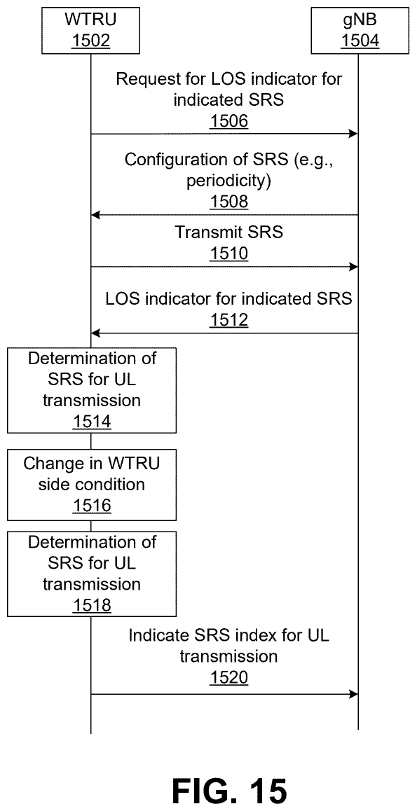

FIG. 15 illustrates another example call flow between a WTRU 1502 and a gNB 1504. As shown in FIG. 15, the WTRU 1502 may send a request to the network 1504 for a LOS indicator for the indicated SRS at 1506. The WTRU 1502 may receive SRS configurations from the network 1504 at 1508. The WTRU 1502 may transmit the configured SRS to the network 1504 at 1510. The WTRU 1502 may receive the LOS indicator for the indicated SRS at 1512. The WTRU 1502 may determine to associate the transmission spatial filter for uplink channel with the SRS with the highest LOS indicator at 1514. The WTRU 1502 may detect a change in a WTRU-side condition (e.g., LOS indicator) at 1516. The WTRU 1502 may determine to update the spatial transmission filter for the uplink channel at 1518. The WTRU 1502 may report to the network 1504 the updated relationship between the SRS and the uplink channel at 1520.

The WTRU may receive a request to become a contributor for data collection. The WTRU may send a response to agree to become a contributor for data collection. The WTRU may receive a response from the network to confirm registration as a contributor. The WTRU may send a request for a LOS indicator for the indicated SRS(s) (e.g., SRS resource ID). The WTRU may (e.g., additionally) indicate a TRP ID (e.g., if available at the WTRU) and SRS ID (e.g., SRS resource ID). The WTRU may receive, from the network, configurations to transmit SRSs (e.g., which includes the indicated SRS(s)). The WTRU may transmit the configured SRSs. The WTRU may receive, from the network, a LOS indicator for the indicated SRS(s). The WTRU may receive a request to determine the transmission spatial filter based on the LOS indicator(s) (e.g., the highest LOS indicator) associated with the SRS(s). The WTRU may determine to associate PUSCH with the SRS with the highest LOS indicator value. The WTRU may determine spatial association based on the destination TRP (e.g., the indicated TRP) and LOS indicator.

Ground truth may be obtained from the network. In Life Cycle Management (LCM), the WTRU may need to acquire ground truth(s) to check the performance of AIML model(s) at the WTRU. In some examples, a ground truth may refer to the accurate, real-world data or labels used as a benchmark to train and evaluate an AI/ML model (e.g., a ground truth may be what the AI/ML model is supposed to learn or predict). The WTRU may receive an AIML model from a training server which was trained with the ground truth at a certainty quality. If the WTRU is to report measurements to receive the ground truth from the LMF and the ground truth is generated by the LMF based on implementation, the WTRU may determine whether quality of the ground truth generated by the LMF is aligned with the quality of the ground truth used by the training server. Examples of quality of the ground truth (e.g., WTRU location) may be accuracy of the ground truth (e.g., uncertainty of the ground truth is several tens of centimeters) and/or validity duration of the ground truth (e.g., the ground truth should be valid for 60 minutes after it is generated). The WTRU may include, in the request for the ground truth, a required quality (e.g., desired accuracy of the ground truth, desired validity duration for the ground truth).

A WTRU request to generate the ground truth by the LMF may be disclosed herein. A relationship between a WTRU and a training server may be disclosed herein.

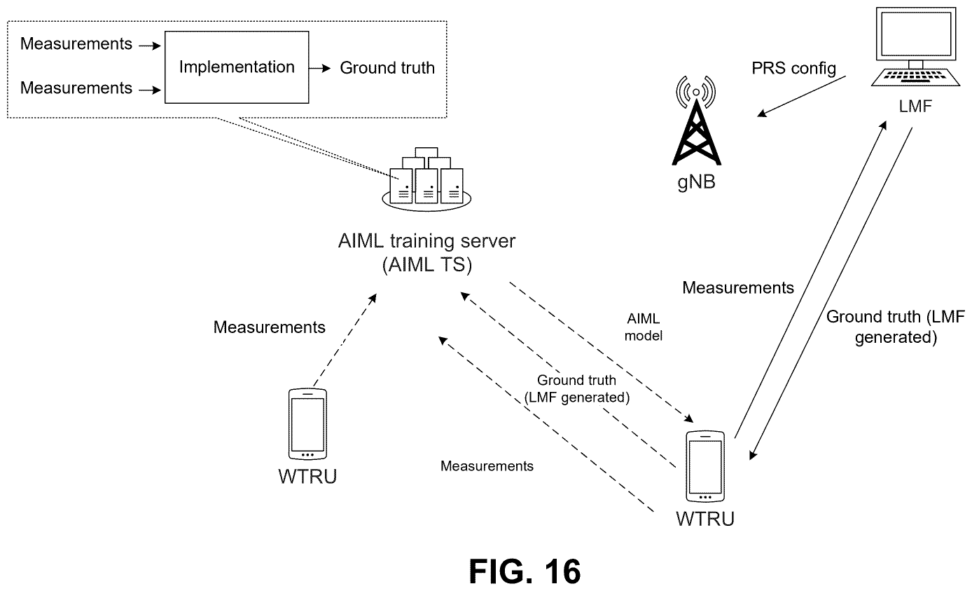

FIG. 16 illustrates an example of a relationship between one or more WTRUs, an AIML training server, an LFM, and a gNB. As shown in FIG. 16, the WTRU may obtain an AIML model(s) from the training server. The WTRU may report measurements and/or ground truth (e.g., WTRU location) to the training server. The training server may collect measurements and/or ground truth from WTRUs.

The WTRU may report measurements to the network (e.g., LMF). The WTRU may be configured to receive DL-RS (e.g., PRS) from the network, make measurements and report the measurements to the network.

The network (e.g., LMF) may determine the ground truth based on the measurements made by the WTRU on the received DL-RS (e.g., PRS) or measurements made by the network (e.g., gNB) on the received UL RS (e.g., SRS) transmitted by the WTRU.

Details of the WTRU's request for the ground truth may be disclosed herein. The WTRU may receive DL-RS configurations from the network. The WTRU may receive a request to make measurements on the DL-RS. The received DL-RS configurations may be for the purpose of positioning, communication and/or data collection purpose.

The WTRU may determine to send a request to the network for a ground truth (e.g., WTRU location). The WTRU may receive a request, from the network, to report measurements (e.g., timing, phase, power measurements) to the network so that the network can determine the location of the WTRU.

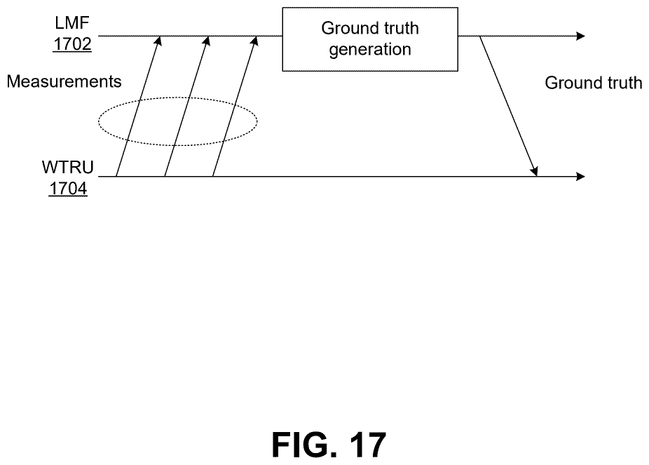

FIG. 17 illustrates an example of a relationship between an amount of measurements reported by a WTRU 1704 and a quality of a generated ground truth. As shown in FIG. 17, the WTRU 1704 may report measurements to an LMF 1702. The LMF 1702 may generate the ground truth (e.g., WTRU location) based on the measurements reported by the WTRU 1704. The WTRU 1704 may receive the ground truth from the LMF 1702.

The WTRU may send a request to the network to determine the ground truth in a specific manner. For example, the WTRU may send a request to the network to use the indicated amount of measurements to determine the ground truth. The request from the WTRU may contain one or more of the following: a duration of measurements used to determine the ground truth (e.g., the duration may be expressed in terms of the number of symbols, slots or seconds); an amount (e.g., number of measurement occasions) of measurements used to determine the ground truth (e.g., each measurement occasion may consist of DL symbols, slots or frames); a start/end time of measurements (e.g., measurements made on the received PRS) to be used to determine the ground truth; frequency resources to be used for determination of the ground truth (e.g., number of frequency layers, carriers, bandwidths, bandwidth parts to be aggregated, etc.); a preferred set of measurements based on which the ground truth shall be determined; and/or an accuracy, uncertainty or quality of measurements to use.

The request from the WTRU may contain a duration of measurements used to determine the ground truth. The measurements collected over the indicated duration may be aggregated for determination of the ground truth.

The request from the WTRU may contain a start/end time of measurements (e.g., measurements made on the received PRS) to be used to determine the ground truth. The WTRU may indicate the start and/or end time of the measurement time window during which the WTRU or the network makes measurements on the received DL-RS or UL RS, respectively.

The request from the WTRU may contain a preferred set of measurements based on which the ground truth shall be determined. For example, the WTRU may indicate to the network a subset of DL-RSs (e.g., DL-RS resource ID) whose measurements shall be used to determine the ground truth.

The request from the WTRU may contain an accuracy, uncertainty or quality of measurements to use. For example, the WTRU may indicate the uncertainty of measurements to be less than the indicated threshold. The WTRU may ask the network to process (e.g., average) measurements such that the uncertainty of measurements used by the network to determine the ground truth satisfies the quality requirement (e.g., below an indicated threshold).

The WTRU may send measurements with a timestamp. The WTRU may send a request to the LMF for the ground truth, where the request may include the first and second timestamp which correspond to the start and end time of the measurements to be used for generation of the ground truth, respectively.

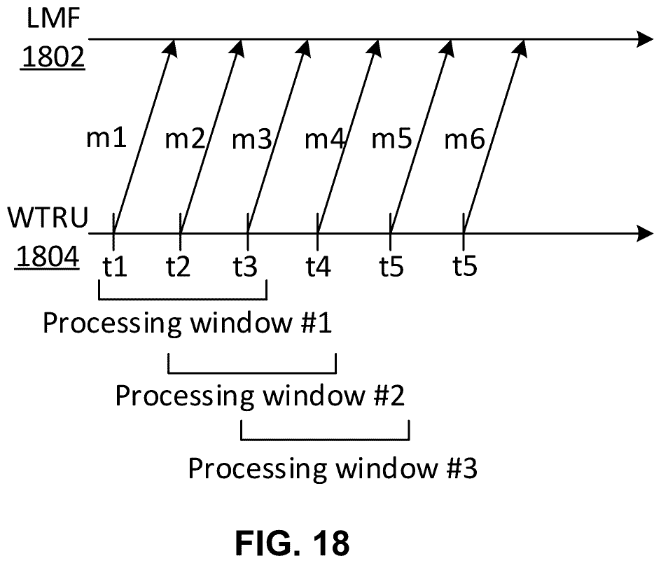

FIG. 18 illustrates an example of a start and end time of measurements to be used for generation of ground truth(s). As shown in FIG. 18, a WTRU 1804 may report one or more measurements (e.g., measurements, m1, m2, m3, m4, m5 and m6 shown in FIG. 18) at one or more (e.g., six) different time instances (e.g., times t1, t2, t3, t4, t5 and t6 shown in FIG. 18, respectively) to a network (e.g., LMF 1802). The WTRU 1804 may send a request to use measurements from a first time period (e.g., t1 to t3, indicated by processing window #1 in FIG. 18), to generate the first ground truth. The WTRU 1804 may send a request to generate a second ground truth based on measurements reported during a second time period (e.g., between t2 and t4, indicated by processing window #2 in FIG. 18). The WTRU 1804 may send a request to generate a third ground truth based on measurements reported during a third time period (e.g., between t3 and t5, indicated by processing window #3 in FIG. 18). The WTRU 1804 may indicate or be configured with a sliding window for a (e.g., each) ground truth. The WTRU 1804 may indicate a time shift that may be applied to the time window for a (e.g., each) ground truth to be generated by the LMF 1802.

The WTRU may send a request to the network (e.g., LMF) for a positioning method with which the WTRU desires the ground truth to be generated by the network. For example, the requested positioning method(s) may include one or more of the following: DL-TDOA (e.g., where the ground truth is determined based on at least timing measurements made on DL-RS); DL-AoD (e.g., where the ground truth is determined based on at least angle or power measurements made on DL-RS); UL-TDOA (e.g., where the ground truth is determined based on at least timing measurements made on UL RS); UL-AoA (e.g., where the ground truth is determined based on at least angle or power measurements made on DL-RS); Multi-RTT (e.g., where the ground truth is determined based on at least timing measurements made on DL-RS and UL RS); and/or RAT independent positioning method (e.g., GNSS, WiFi, sensor-based positioning methods, etc.).

The WTRU may determine to send a request to the network for a preferred positioning method based on its WTRU capability. The WTRU may include in the request that the indicated positioning method can be handled by the WTRU based on its capability. The WTRU may receive a request from the network for WTRU capabilities for positioning methods the WTRU can support (e.g., UL-TDOA). The network may determine the positioning method to implement to generate the ground truth based on the reported WTRU capability.

The WTRU may send a request to the network for preferred DL-RS or UL RS configurations (e.g., periodicity, number of TRPs, TRP ID, number of PRS or SRS resources, number of PRS or SRS resource sets, spatial information, etc.) so that the network (e.g., LMF) can generate the ground truth based on the measurements made on the UL RS transmitted by the WTRU or reported by the WTRU.

The WTRU may ask for periodic provision of the ground truth from the network. The WTRU may send an indication to start and/or finish provision of the ground truth from the network. The WTRU may report measurements periodically to the network. The network (e.g., LMF) may determine the ground truth based on the measurements reported by the WTRU periodically. The WTRU may ask for number of instances of ground truth to be provided (e.g., ground truth provided at every 5 seconds for a period of (e.g., the next) 15 seconds) or aperiodic provision (e.g., one-time) of a ground truth. The WTRU may receive a message from the network to terminate periodic or aperiodic provision of the ground truth. The WTRU may receive a cause of termination from the network (e.g., not enough measurements).

The WTRU may determine to send a request for the ground truth based on the configured requirement for quality of the ground truth. The WTRU may be configured with the requirement by the network (e.g., LMF) or an external server (e.g., OTT server, AIML training server). The WTRU may determine the quality of requirement from the service that originated at the WTRU application. For example, the WTRU may determine the accuracy or uncertainty requirement for the ground truth from the Mobile Originated Location Request (e.g., MO-LR).

An association between measurement(s) and ground truth may be disclosed herein. Measurement(s) and ground truth may be associated with one or more of the following attributes for the measurement: a timestamp indicating when the measurements are made or corresponding RS is transmitted; TRPs at which measurements are made; a geographical area in which measurements are made; a spatial transmission direction of UL RS or DL RS; and/or an identification of the WTRU (e.g., WTRU ID).

The WTRU may associate a timestamp with measurements, and report both measurements and associated timestamp to the network. The timestamp may indicate when the measurements are made. The WTRU may send a request to the network to associate measurements and the generated ground truth by indicating timestamp(s).

For example, the WTRU may report one or more (e.g., three) instances of measurements, (e.g., each) associated with a timestamp (e.g., T1, T2 and T3). The WTRU may send a request to the network to use measurements associated with one or more timestamp(s) (e.g., T1 and T2) to generate the ground truth. The WTRU may receive a message from the network indicating measurements associated with the ground truth. For example, the WTRU may receive an indication from the network (e.g., LMF) that the generated ground truth is associated with measurements associated with one or more timestamp(s) (e.g., T1, T2 and T3).

The WTRU may be configured with UL RS configurations so that the network can make measurements on the received UL RS and generate the ground truth based on the measurements. The WTRU may associate a timestamp with transmission instance(s) of UL RS (e.g., SRS). For example, the WTRU may transmit an instance of transmission of SRS with a timestamp, where an instance may consist of SRS symbol(s), or slot(s) or frame(s) that contain SRS symbol(s).

The WTRU may transmit one or more (e.g., 3) instances of SRS, where a (e.g., each) instance may be associated with a timestamp (e.g., T1, T2 and T3). The WTRU may send a request to the network to associate measurements made on SRS that are associated with one or more timestamps (e.g., the timestamp T1 and T2). The WTRU may receive a message from the network indicating the instance(s) of UL transmissions used to determine the ground truth. For example, the WTRU may receive the ground truth from the LMF and indication that measurements made on SRSs at one or more transmission instances (e.g., transmission instances T1, T2 and T3) are used to determine the ground truth.

The WTRU may send a required accuracy (e.g., +10 cm) of the ground truth to the network. The WTRU may receive a request to report measurements at indicated periodicity from the network. The WTRU may receive the ground truth from the network once the requested accuracy for the ground truth is reached. The WTRU may send the required accuracy and a request for aperiodic measurement report. As a response for the request from the WTRU, the WTRU may receive from the network the amount of measurements (e.g., number of measurement instances, accuracy or uncertainty of measurements) required to be reported for the desired accuracy. The WTRU may be configured with start and/or end time for reporting measurements. The WTRU may receive, from the network, an activation or deactivation command for measurement reporting.

The WTRU may send a request for activation (e.g., via RRC message, LPP message, UL-MAC or UCI) of the delivery of the ground truth from the network. The WTRU may send a request for deactivation of delivery of the ground truth from the network.

The WTRU may determine the quality or accuracy of the ground truth provided by the network. The WTRU may determine the quality or accuracy of the ground truth based on the range of the ground truth(s) received by the network or statistics of the ground truth(s) (e.g., mean, standard deviation). The WTRU may report the determined quality or accuracy of the ground truth to the network and/or training server.

Rejection behavior may be disclosed herein. The WTRU may receive a response from the network rejecting the WTRU's request for the ground truth. The response from the network may contain the cause of the rejection (e.g., not being able to meet the requested quality of the ground truth, insufficient amount of measurements, quality of measurements not sufficient enough to generate the ground truth, etc.). The WTRU may determine to perform one or more of the following: respond to the network that the AIML-based positioning at the WTRU cannot be completed; respond to the network that the performance monitoring of AIML model(s) at the WTRU cannot be completed at the WTRU; and/or use the configured fallback positioning method (e.g., DL-TDOA, DL-AoD) instead of the AIML-based positioning method.

A relationship between UL RS and ground truth may be disclosed herein. The WTRU may send a request to the network how the LMF should determine the ground truth(s) based on the UL RS (e.g., SRS) transmitted by the WTRU. The WTRU may send a request for preferred SRS configurations to the network. The WTRU may determine to send a request for preferred method of determination of the ground truth after the WTRU receives a UL RS configuration from the network. The received UL RS configurations may be for positioning, data collection and/or the purpose of communication. The WTRU may send a request for measurements made by the network (e.g., LMF) based on the SRS transmitted by the WTRU. The WTRU may send a request for the ground truth determined using the measurements made from the SRS transmitted by the WTRU.

The WTRU may send a request to use the first set of UL RSs for determination of the ground truth. The WTRU may determine the first set of UL RSs based on the second set of configured UL RSs, where the second set of UL RSs may be used for the purpose of positioning, communication or data collection.

The WTRU may indicate preferred SRS configurations (e.g., SRS resource IDs) for determination of the ground truth. For example, the WTRU may send a request to the network to determine a ground truth based on one or more of the following: identification of SRS via SRS resource ID and/or SRS resource set ID; carrier frequency to be used for data collection; frequency resources (e.g., carrier frequencies, carrier frequency components, bandwidth, number of bands or carrier frequency components to be aggregated, indices of bands or carrier frequency components) to be used for determination of the ground truth; a number of transmission occasions of UL RS (e.g., the WTRU may send a request to use at least N transmission occasions of SRS to determine the ground truth); a periodicity of transmission of UL RS (e.g., the WTRU may send a request to use specific periodicity of SRS to determine the ground truth); a number of symbols for UL RS (e.g., the WTRU may send a request to use specific number of SRS symbols to determine the ground truth); a duration (e.g., indicated by a time window) of transmission of UL RS (e.g., the WTRU may send a request to use specific duration of SRS to determine the ground truth (e.g., measurements made over N seconds)); a spatial relationship information or AoD of UL RS (e.g., the WTRU may send a request to the network to use SRSs transmitted in the range of N and M degrees with respect to a reference point); and/or a destination of SRS (e.g., reception point ID, TRP ID, cell IDs, area IDs (e.g., the WTRU may send a request to use RP (reception point) #1 and RP #2 as the target direction for transmission of SRS).

Conditions that trigger the request may be disclosed herein. The WTRU may determine to send a request for the ground truth based on a trigger condition. Examples of trigger conditions may be one or more of the following: area; timing; and/or a message from the network.

Examples of trigger conditions may include an area. For example, the WTRU may determine to send a request to the LMF for a ground truth if the WTRU is in a configured area(s) (e.g., indicated by a cell ID). The WTRU may determine that the training server cannot provide ground truths in certain areas, and the WTRU may (e.g., need to) request for ground truths from the LMF.

Examples of trigger conditions may include a timing. For example, the WTRU may need to obtain ground truths at specific time or timings (e.g., periodically). The WTRU may send a request to the LMF for ground truths at configured timings.

Examples of trigger conditions may include a message from the network. For example, the WTRU may receive a message from the network that the ground truth can be generated based on the indicated positioning method(s) and/or conditions (e.g., ground truths can be provided by an indicated positioning method, quality information about the ground truths (e.g., uncertainty of a ground truth, accuracy of ground truth), timings at which the ground truths can be provided). The WTRU may receive such a message via a broadcast message (e.g., SIB). Based on the received message, the WTRU may send a request to the network for ground truths.

The WTRU may determine to set up a session with the network during which the WTRU can obtain the ground truth. The WTRU may send a request to the network for the session. The session may be terminated based on one or more of the following conditions: a termination message from the network is received; the amount of ground truths received by the network reached the requested amount by the WTRU; the duration of the session reached the configured duration (e.g., expressed in seconds); and/or a change of LMF. For a change of LMF, if the WTRU moves out of the coverage area of the LMF, the WTRU may need to reconnect with the LMF at a new location. The WTRU may determine to terminate the session and request a new session with the new LMF.

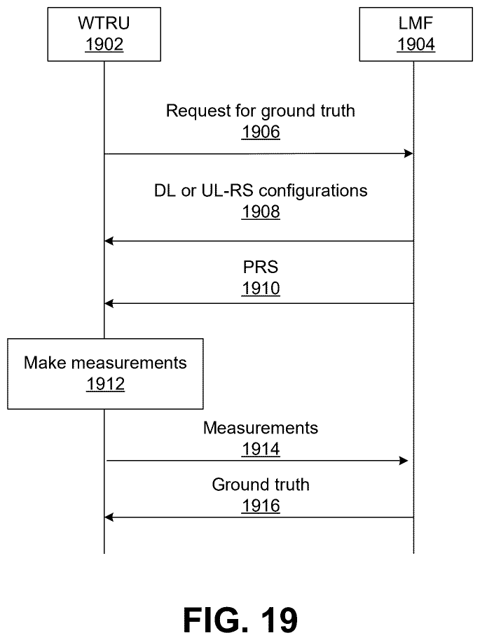

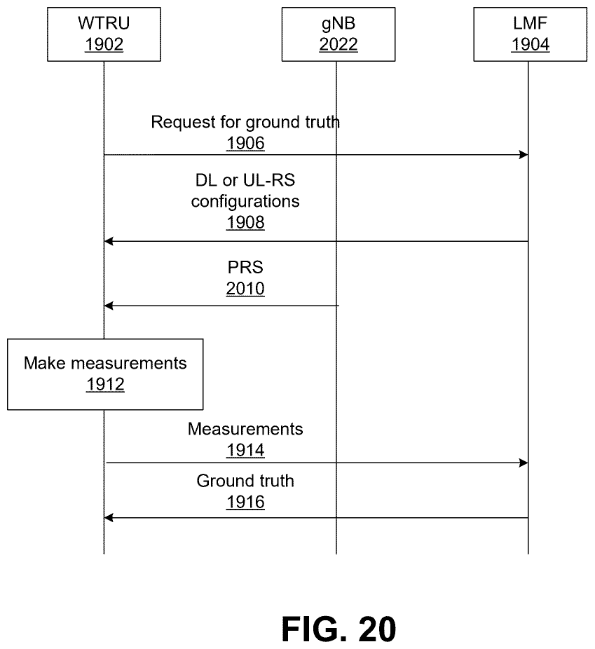

FIGS. 19 and 20 illustrate examples of requesting and acquisition of a ground truth. For example, as shown in FIGS. 19 and 20, the WTRU 1904 may determine to send a request for ground truth to the network (e.g., LMF 1904) at 1906. The WTRU 1904 may receive DL configurations from the network 1904 at 1908. The WTRU 1904 may receive PRS from the network. For example, as shown in FIG. 19, the WTRU 1904 may receive the PRS from the LMF 1904 at 1910. Alternatively, the WTRU 1904 may receive the PRS from the gNB 2022 at 2010. As shown in FIGS. 19 and 20, the WTRU 1904 may make measurements on the received PRS at 1912. The WTRU 1904 may report measurements to the network 1904 at 1914. The WTRU 1904 may receive the ground truth for the measurements reported by the WTRU 1904 at 1916.

The WTRU may send a request to the network to determine the ground truth with indicated amount of measurements and positioning method based on the quality requirement. The WTRU may send a request, to the LMF, for a ground truth (e.g., the WTRU's location). In the request, the WTRU may request the network for at least the following for DL and/or UL measurements to be used to determine the ground truth: a duration of measurements, an amount (e.g., number of measurement occasions) of measurements, and/or a start/end time of measurements. The WTRU may send preferred PRS and/or SRS configurations (e.g., number of TRPs) for determination of the ground truth. The request may include preferred positioning method(s) (e.g., including RAT independent or RAT dependent) to obtain the ground truth. The WTRU may receive a response from the network with the duration and/or amount of measurements to be used for determining the ground truth. The WTRU may receive PRS and/or SRS configurations from the network. The WTRU may report the measurements to the network. The WTRU may receive the ground truth from the network.

By obtaining assistance data for UL transmission, signaling overhead between the WTRU and network can be reduced as the WTRU can determine an optimal transmission spatial filer for UL. By indicating the preferred method or configuration for generation of the ground truth to the network, quality of the ground truth used for performance monitoring at the WTRU can be maintained.

1. A wireless transmit/receive unit (WTRU) comprising a processor configured to:
transmit, to a network, a request for one or more line of sight (LOS) indicators, wherein each LOS indicator is associated with a respective sounding reference signal (SRS);
receive, from the network, one or more configurations to transmit the respective SRSs associated with the one or more LOS indicators;
transmit, to the network, the respective SRSs associated with the one or more LOS indicators;
receive, from the network, the one or more LOS indicators associated with the respective SRSs;
determine a first LOS indicator of the received one or more LOS indicators, wherein the first LOS indicator has a highest value among the received one or more LOS indicators;
associate an uplink channel with an SRS associated with the first LOS indicator; and
transmit one or more uplink transmissions using the uplink channel associated with the SRS associated with the first LOS indicator.

2. The WTRU of claim 1, wherein the processor is further configured to determine a spatial filter to transmit the one or more uplink transmissions based on the received one or more LOS indicators.

3. The WTRU of claim 1, wherein the uplink channel comprises a physical uplink shared channel (PUSCH).

4. The WTRU of claim 1, wherein the processor is further configured to:
receive, from the network, a request to become a contributor for data collection; and
transmit, to the network, a response message.

5. The WTRU of claim 4, wherein the processor is further configured to receive, from the network, a confirmation message confirming registration of the WTRU as a contributor for data collection.

6. The WTRU of claim 1, wherein the request for the one or more LOS indicators comprises identifiers associated with the respective SRSs associated with the one or more LOS indicators.

7. The WTRU of claim 1, wherein the processor is further configured to:
determine that a trigger condition is satisfied;
update the one or more LOS indicators associated with the respective SRSs;
determine a second LOS indicator of the one or more LOS indicators, wherein the second LOS indicator has a highest value among the updated one or more LOS indicators; and
associate the uplink channel with an SRS associated with the second LOS indicator.

8. The WTRU of claim 7, wherein the processor is further configured to transmit, to the network, an indication that the uplink channel is associated with the SRS associated with the second LOS indicator.

9. The WTRU of claim 7, wherein the processor being configured to determine that the trigger condition is satisfied comprises the processor being configured to determine that at least one of an orientation of the WTRU or a location of the WTRU has changed by a threshold amount.

10. The WTRU of claim 1, wherein the request for the one or more LOS indicators comprises one or more transmission-reception point (TRP) identifiers (IDs).

11. A method implemented in a wireless transmit/receive unit (WTRU), the method comprising:
transmitting, to a network, a request for one or more line of sight (LOS) indicators, wherein each LOS indicator is associated with a respective sounding reference signal (SRS);
receiving, from the network, one or more configurations to transmit the respective SRSs associated with the one or more LOS indicators;
transmitting, to the network, the respective SRSs associated with the one or more LOS indicators;
receiving, from the network, the one or more LOS indicators associated with the respective SRSs;
determining a first LOS indicator of the received one or more LOS indicators, wherein the first LOS indicator has a highest value among the received one or more LOS indicators;
associating an uplink channel with an SRS associated with the first LOS indicator; and
transmitting one or more uplink transmissions using the uplink channel associated with the SRS associated with the first LOS indicator.

12. The method of claim 11, further comprising determining a spatial filter to transmit the one or more uplink transmissions based on the received one or more LOS indicators.

13. The method of claim 11, wherein the uplink channel comprises a physical uplink shared channel (PUSCH).

14. The method of claim 11, further comprising:
receiving, from the network, a request to become a contributor for data collection; and
transmitting, to the network, a response message.

15. The method of claim 14, further comprising receiving, from the network, a confirmation message confirming registration of the WTRU as a contributor for data collection.

16. The method of claim 11, wherein the request for the one or more LOS indicators comprises identifiers associated with the respective SRSs associated with the one or more LOS indicators.

17. The method of claim 11, further comprising:
determining that a trigger condition is satisfied;
updating the one or more LOS indicators associated with the respective SRSs;
determining a second LOS indicator of the one or more LOS indicators, wherein the second LOS indicator has a highest value among the updated one or more LOS indicators; and
associating the uplink channel with an SRS associated with the second LOS indicator.

18. The method of claim 17, further comprising transmitting, to the network, an indication that the uplink channel is associated with the SRS associated with the second LOS indicator.

19. The method of claim 17, wherein determining that the trigger condition is satisfied comprises determining that at least one of an orientation of the WTRU or a location of the WTRU has changed by a threshold amount.

20. The method of claim 11, wherein the request for the one or more LOS indicators comprises one or more transmission-reception point (TRP) identifiers (IDs).
